(19) United States
(12) Patent Application Publication
(10) Pub. No.: US 2023/0153732 A1
(43) Pub. Date: May 18, 2023

(54) Acquisition Planning System

(71) Applicant: Seventh Sense Consulting, LLC, Woodbridge, VA (US)

(72) Inventors: Lisa Akers, Fort Washington, MD (US); Kito Bradford, Rockville, MD (US); Patrick Shields, Bowling Green, VA (US)

(73) Assignee: Seventh Sense Consulting, LLC, Woodbridge, VA (US)

(21) Appl. No.: 18/156,496

(22) Filed: Jan. 19, 2023

Related U.S. Application Data
(63) Continuation-in-part of application No. 17/589,481, filed on Jan. 31, 2022.
(60) Provisional application No. 63/313,527, filed on Feb. 24, 2022.
(60) Provisional application No. 63/144,363, filed on Feb. 1, 2021.

(51) Int. Cl. G06Q 10/0637; G06Q 50/18

(52) U.S. Cl. CPC G06Q 10/0637; G06Q 50/18

(57) ABSTRACT

Computer software provides process automation for Federal Acquisition Life Cycle, including requirements definition, market research, acquisition planning and preparing the procurement request package. Requirements owners are responsible for articulating mission objectives, developing needs statement and requirements, researching the market, holding exchanges with industry, considering small businesses, estimating cost, planning acquisition, drafting evaluation criteria, and assembling a procurement request package to submit to the CO. Everything relating to a procurement is maintained in one place with activities, notifications, process automation based on user responses, workflow, collaborative platform, document repository, ask-the-expert, educational videos and templates. It facilitates and guides requirements owners through development of requirements to creation of procurement request package. It provides decision support and progress tracking for leadership through dashboard, reports, and portfolio view of upcoming procurements. It strategically aligns and complements existing government contract writing systems. It provides a complete acquisition planning solution.

### RELATED APPLICATIONS

The present application claims the benefit of and priority to U.S. Provisional Patent Application No. 63/313,527 filed Feb. 24, 2022 entitled “Acquisition Planning System” by the same inventors. The present application also claims priority to U.S. patent application Ser. No. 17/589,481 filed Jan. 31, 2022 which claimed the benefit of and priority to U.S. Provisional Patent Application No. 63/144,363 filed Feb. 1, 2021 both by the same inventors and both entitled “Contract Management System.” U.S. patent application Ser. No. 17/589,481 and U.S. Provisional Patent Application No. 63/144,363 and U.S. Provisional Patent Application No. 63/313,527 are all hereby incorporated by reference as if repeated herein in their entirety, including the drawings.

### BACKGROUND

The present invention relates generally to methods and apparatuses for automating business processes, and more particularly to a method and apparatus for automating a business process, such as management of a United States Federal Government procurement contract.

In today's world, the United States government relies heavily on contracts and is by far one of the single largest sources of the procurement of products and services in the United States. In 2020, the federal government spent $681 billion on contracts for products and services which represents the most the government has spent in contracts since fiscal 2010, according to an analysis from Bloomberg Government.

Despite the efforts of Congress and the executive branch to reduce costs and improve the quality of federal acquisitions, many problems still remain. According to the Federal Times, a report by the Government Accountability Office (GAO) GAO-18-627 Report on Federal Acquisitions dated Sep. 12, 2018, states that there are three main areas of improvement that can be made in the federal acquisitions sector: (1) requirements definition, (2) competition and pricing, and (3) contractor oversight.

While the current technology landscape is riddled with solutions that focus on the competition and pricing portion via more traditional contract life cycle management (CLM) software solutions such as Unison Prism, CACI Comprizon Suite, and Oracle's CLM for the Public Sector, there is little to no competition in the government sector for either the requirements definition or contractor oversight areas of improvement noted by GAO.

The present invention is therefore directed to the problem of developing an automated system for managing government contracts that improves the requirements definition and acquisition planning segment of the government procurement cycle.

### SUMMARY OF THE INVENTION

The present invention solves these and other problems by providing a computer software program, Facilitated Intelligent Needs Development™ (FIND™) that provides process automation for the first phase of the Federal Acquisition Life Cycle that included requirements development, market research, acquisition planning, and preparing the procurement request package. Federal employees in the role of a requirements owner are responsible for articulating their related mission objectives. develop their needs statement and requirements, research the market, hold exchanges with industry, consider the use of small business, estimate the cost, plan the acquisition, draft the evaluation criteria, and assemble the procurement request package for submission to the Contracting Officer. The FIND program maintains everything relating to the upcoming procurement in one place with activities, notifications, intelligent process automation based on user response, workflow based on agency thresholds for delegation of authority, collaborative platform, document repository, ask-the-expert, educational videos and templates. The present invention facilitates and guides the requirements owner through the development of the requirements through to the creation of the procurement request package. The present invention also provides decision support and progress tracking for agency leadership through the dashboard, reports, and portfolio view of upcoming procurements.

FIND is strategically aligned and complements the existing government landscape of contract writing systems providers. The present invention provides an acquisition planning (requirement definition, market research, acquisition planning and procurement request package) solution that would interface with the phase 2 contract wring systems.

According to one aspect of the present invention, an exemplary embodiment of an apparatus for performing acquisition planning in preparation for procurement and award of a contract, including a U.S. government contract, includes several elements. In this exemplary embodiment, an on-premises network is designed to be coupled to an external network, and the on-premises network includes a first collaborative server having a front end application server, a first email server and a first database server, said front-end server coupled to the email server and the first database server. The exemplary embodiment also includes an off-premises network designed to be coupled via said external network to the on-premises network. The off-premises network includes a second collaborative server having a web server, a second email server and a second database server, said web server coupled to the second email server, and the second database server. In the exemplary embodiment, the front end application server includes a non-transitive computer readable media having encoded thereon instructions causing the front end application server to provide a facilitated intelligent needs development application. The facilitated intelligent needs development application includes a graphical user interface through which a user, such as a requirements owner, can manage a plurality of aspects of a government contract throughout a life cycle of a government contract, including pre-award acquisition planning to develop requirements, perform market research, develop acquisition plan, and assemble and submit procurement request package to the contracting organization.

In this exemplary embodiment, the facilitated intelligent needs development application may also: enable a plurality of users to manage a plurality of government acquisition needs and procurement requests, wherein said plurality of users includes requirements owners, program managers, contracting officers, contracting officer's representatives, supervisory personnel of said contracting officers and said program managers, security officers, technical representatives, and accountants; and enable supervisory personnel to review requirements, market research, acquisition plans, and procurement request packages of a plurality of government procurement requirements being managed by a plurality of other users.

In this exemplary embodiment, the facilitated intelligent needs development application may also include an early warning system identifying one or more procurement requests at risk of delayed awards, loss of government funds, poorly developed requirements and poorly plan procurements.

In this exemplary embodiment, the facilitated intelligent needs development application may also include an automation process for market research that guides a user through a market research process that prompts the user with questions to shape steps necessary to plan, execute and analyze the market and adequately plan the acquisition in accordance with U.S. government federal acquisition regulations.

In this exemplary embodiment, the facilitated intelligent needs development application may also include a plurality of video tutorials and templates that are linked to one or more of a plurality of specific activities, whereby a user can select any of said plurality of video tutorials and templates to help guide the user when performing one of said plurality of specific activities.

In this exemplary embodiment, the facilitated intelligent needs development application may also provide a plurality of different user roles and allows each of said different user roles to search, filter and access files through multiple ways, including by lists of projects, activities, repositories and reports.

In this exemplary embodiment, the facilitated intelligent needs development application may also provide an ask the experts capability to enable users to ask acquisition-related questions to which said facilitated intelligent needs development application provides ad-hoc responses to new questions that have not been posed by any user or answered previously, as well as pre-programmed responses to questions previously posed or answered.

In this exemplary embodiment, the facilitated intelligent needs development application may also employ a hierarchical data structure starting with a plurality of projects, such as future procurements, each of which employs a plurality of activities, which in turn employs a plurality of action items for each activity, and a plurality of notifications related to one activity or one action item.

According to another aspect of the present invention, an exemplary embodiment of a non-transitive computer readable media has encoded thereon a plurality of instructions causing a processor to provide a facilitated intelligent needs development application. The facilitated intelligent needs development application includes a graphical user interface through which a user, such as a requirements owner, can manage a plurality of aspects of a government project throughout a life cycle of a government procurement, including requirements development, market research, acquisition planning, and procurement request submission to contracting office. The facilitated intelligent needs development application: (i) enables a plurality of users to manage a plurality of government projects/procurement requests, wherein said plurality of users includes requirements owners, program managers, contracting officers, contracting officer's representatives, supervisory personnel of said contracting officers and said program managers, security officers, technical representatives, and accountants; (ii) enables one or more supervisory personnel to review quality and schedule planned of a plurality of government procurement requests being managed by a plurality of other users; (iii) includes an early warning system identifying one or more procurement requests at risk of delayed awards, loss of government funds, poorly developed requirements and poorly plan procurements; (iv) includes a plurality of video tutorials and templates that are linked to one or more specific activities whereby a user can select any of said plurality of video tutorials and templates to help guide the user when performing one of said one or more specific activities; (v) provides a plurality of different user roles and allows each of said different user roles to search, filter and access files through multiple ways, including by lists of projects, activities, repositories and reports; and (vi) provides an ask the experts capability an ask the experts capability to enable users to ask acquisition-related questions to which said facilitated intelligent needs development application provides ad-hoc responses to new questions that have not been posed by any user or answered previously, as well as pre-programmed responses to questions previously posed or answered.

According to yet another aspect of the present invention, an exemplary embodiment of a method for planning a government procurement request using an intelligent process embedded in a facilitated intelligent needs development application for execution on a server includes the steps of: (i) providing a graphical user interface through which a user, such as a requirements owner, can manage a plurality of aspects of a government procurement requests throughout a life cycle of a government procurement, including requirements development, market research, acquisition planning and procurement request submission to the contracting office; (ii) providing access to the facilitated intelligent needs development application by predetermined user roles for a plurality of users to manage a plurality of government procurements, wherein said plurality of users includes one or more of the following: requirements owner, program manager, contracting officers, contracting officer's representatives, supervisory personnel of said contracting officers and said program managers, security officers, technical representatives, and accountants; (iii) providing access to the facilitated intelligent needs development application to one or more supervisory personnel to enable said one or more supervisory personnel to review the planning and analysis of a plurality of government procurement requests being managed by a plurality of other users; (iv) identifying automatically by an early warning system one or more projects at risk of delayed awards, loss of government funds, poorly developed requirements and poorly plan procurements; (v) automating a process for performing market research that guides a user through a market research methods and consideration process that prompts the user with questions to shape steps necessary to complete the market analysis; (vi) providing one or more video tutorials and templates that are linked to one or more specific activities, whereby a user can select any of the one or more video tutorials and templates to help guide the user when performing one of said one or more specific activities; (vii) providing a plurality of different user roles and allowing each of said different user roles to search, filter and access files through multiple ways, including by lists of projects, activities, repositories and reports; and (viii) providing an ask the experts capability to enable users to ask acquisition-related questions to which said facilitated intelligent needs development application provides ad-hoc responses to new questions that have not been posed by any user or answered previously, as well as pre-programmed responses to questions previously posed or answered.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 depicts a hardware architecture of an exemplary embodiment of a system for acquisition planning according to one aspect of the present invention.

FIG. 2 depicts a relationship of entities for the software of an exemplary embodiment of according to another aspect of the present invention.

FIGS. 3A-B, 4A-B, 5A-B, 6A-B, 7A-B, 8A-B, 9A-B, 10A-B, 11, 12A-C, 13-21, 22A-B and 23 depict various screen shots of a system for acquisition planning from requirement definition through creation of procurement requisition package, such as projects according to yet another aspect of the present invention.

FIGS. 24-27 depict the process for managing the federal acquisition life cycle that this invention supports.

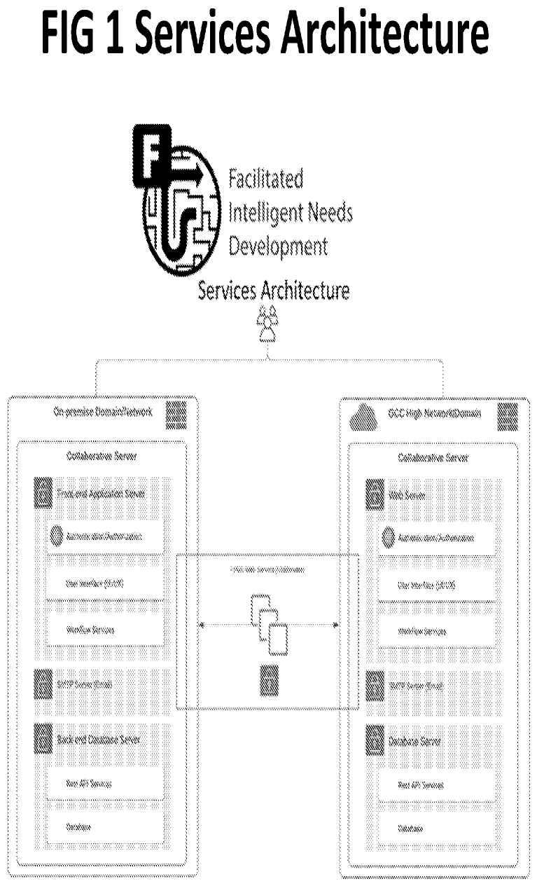

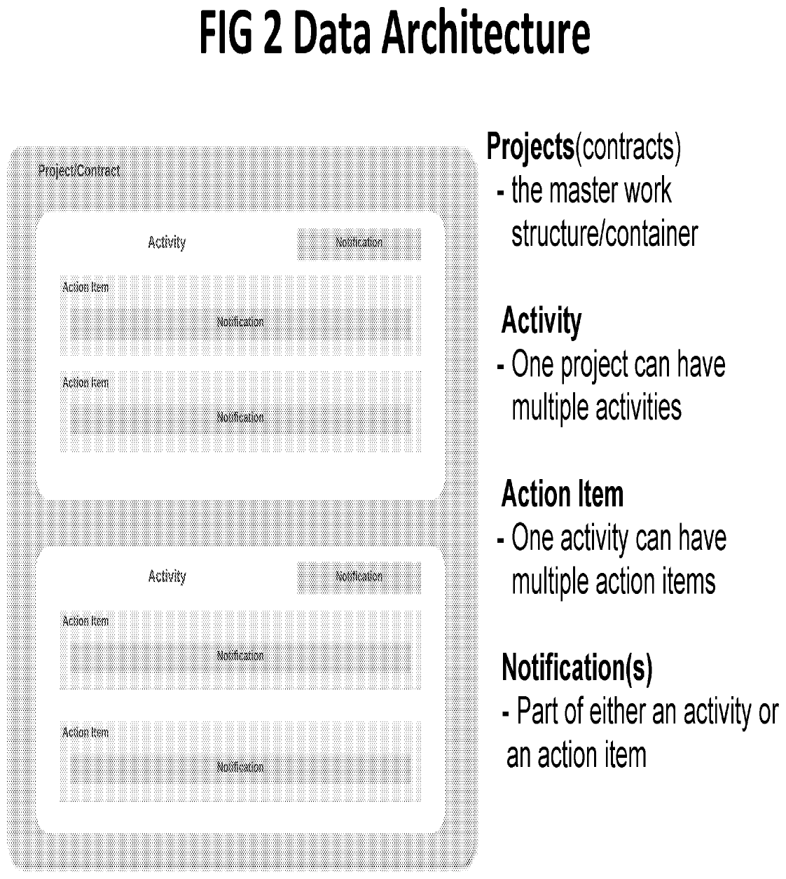

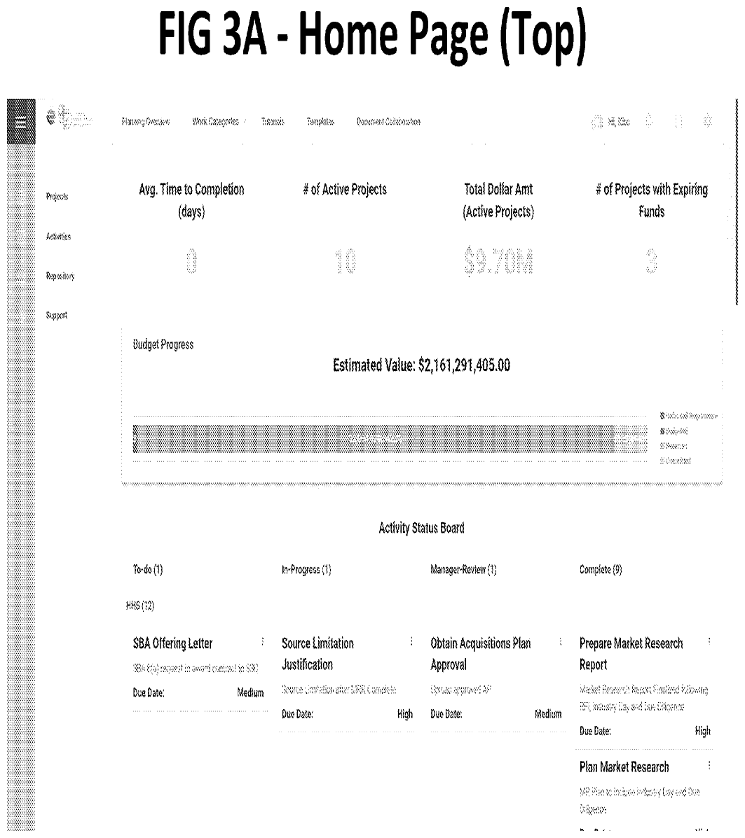

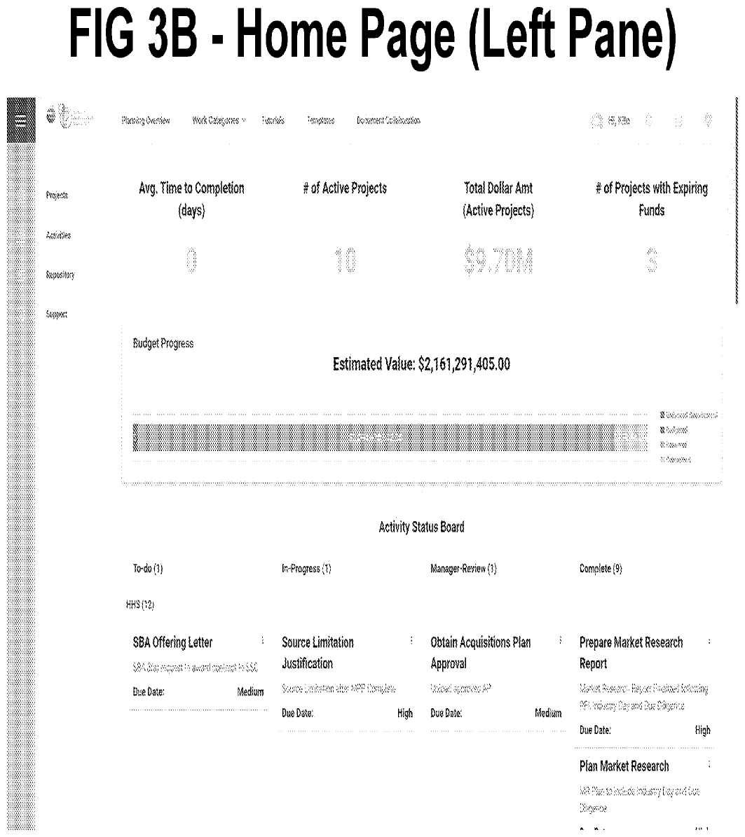

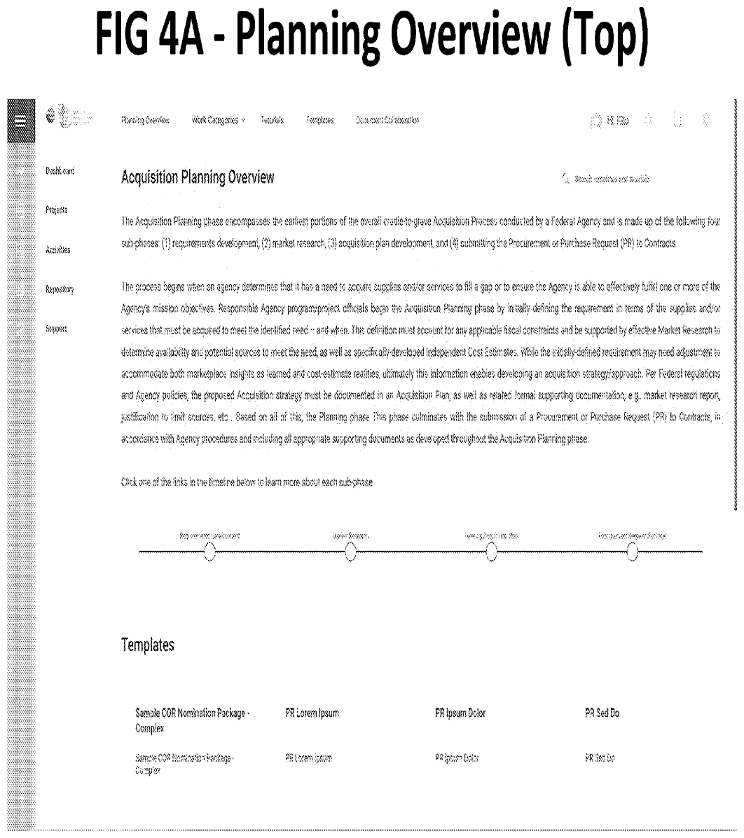

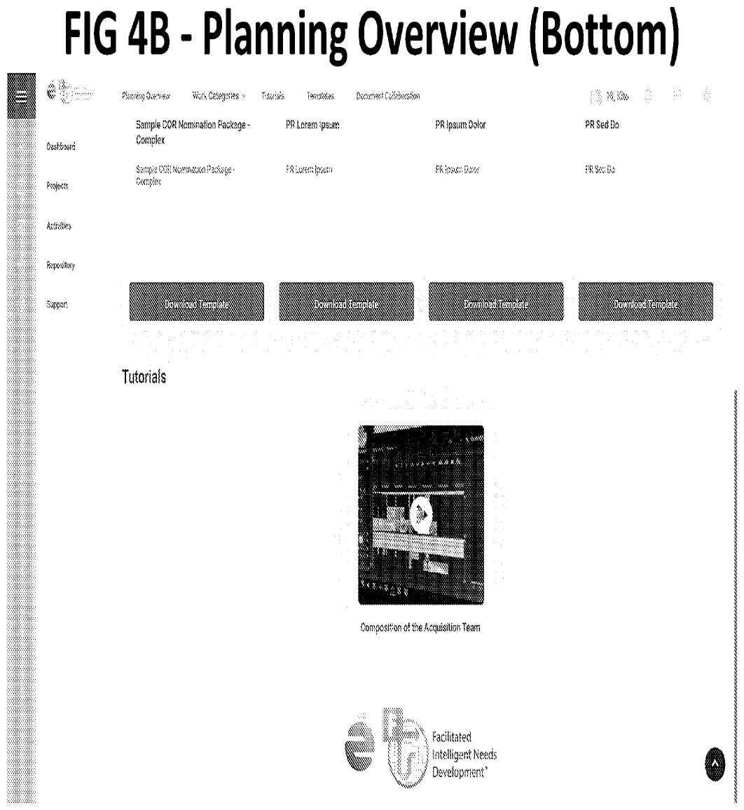

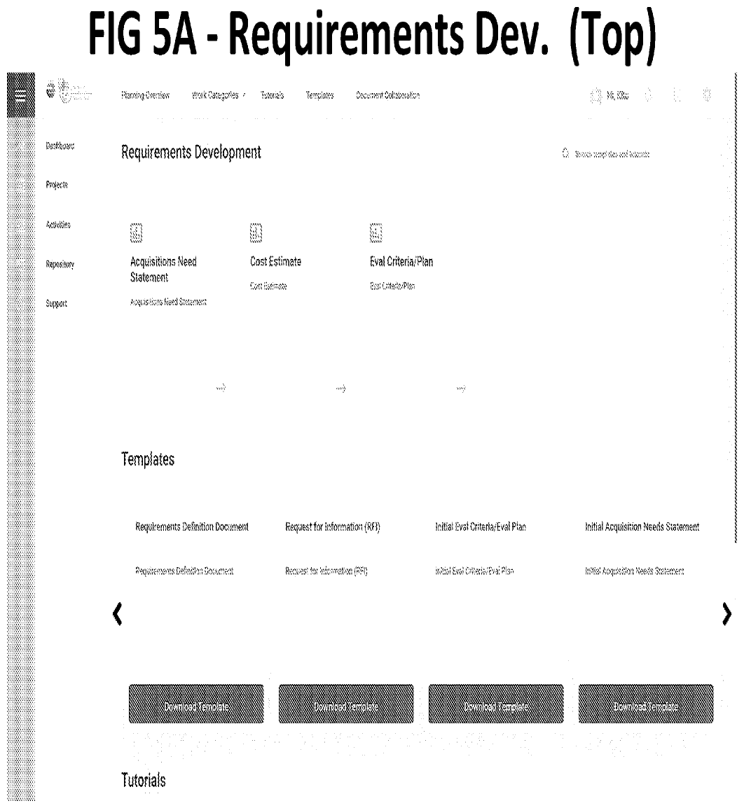

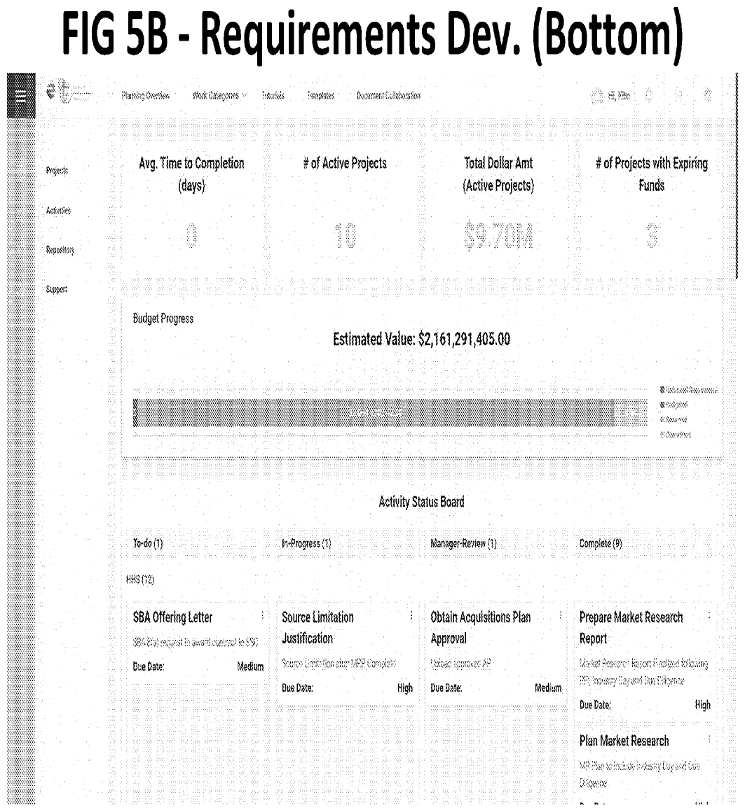

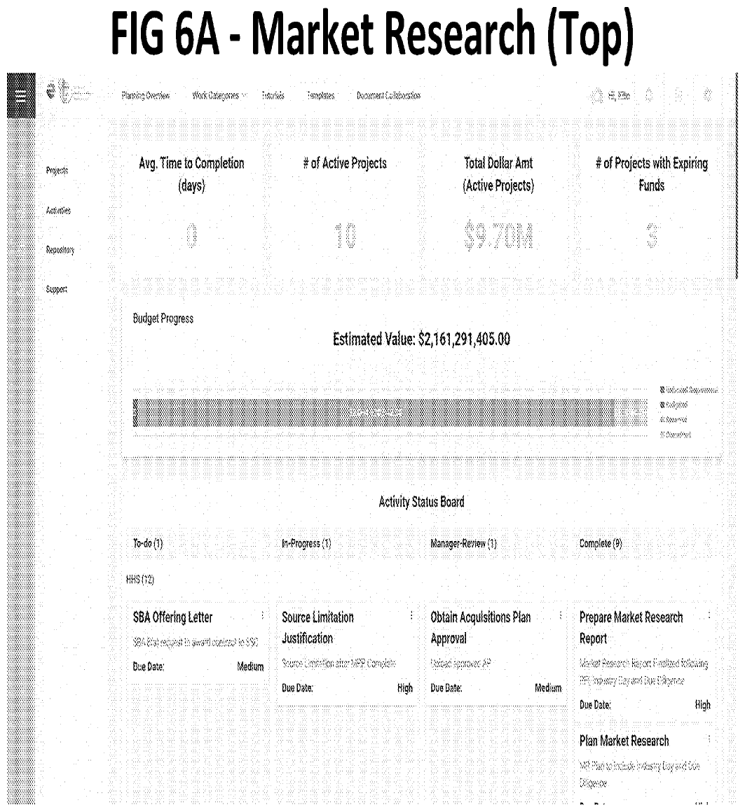

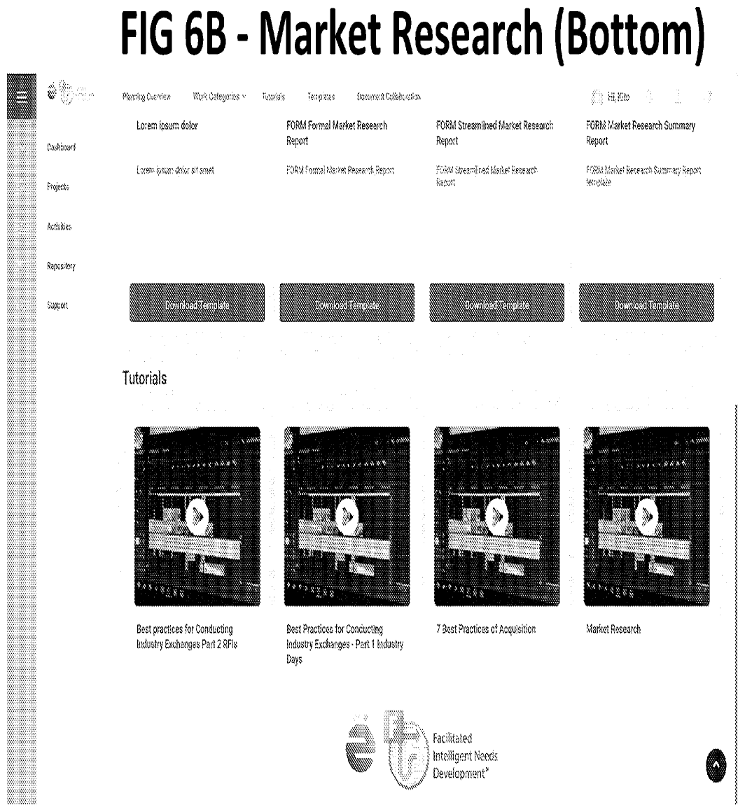

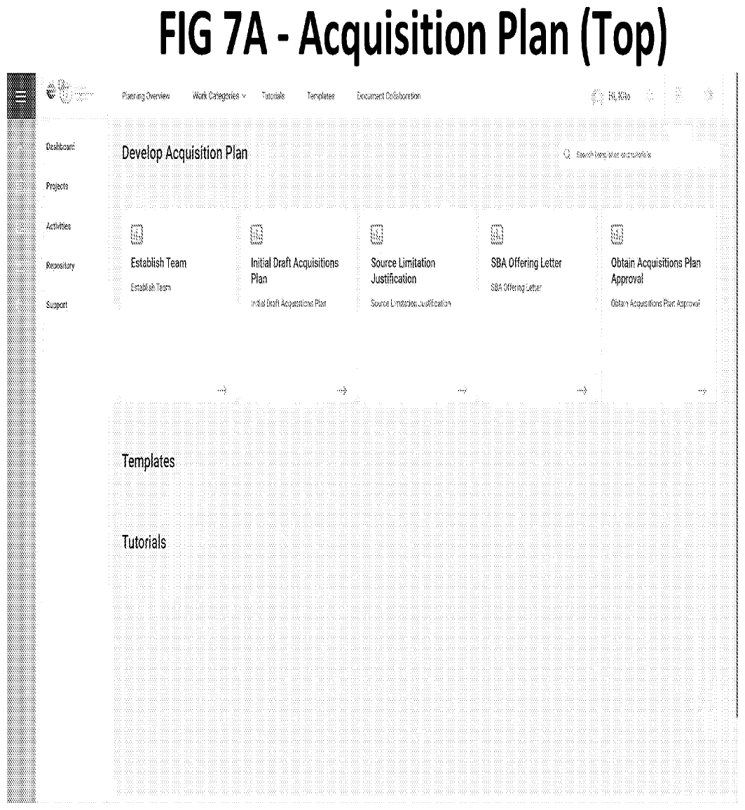

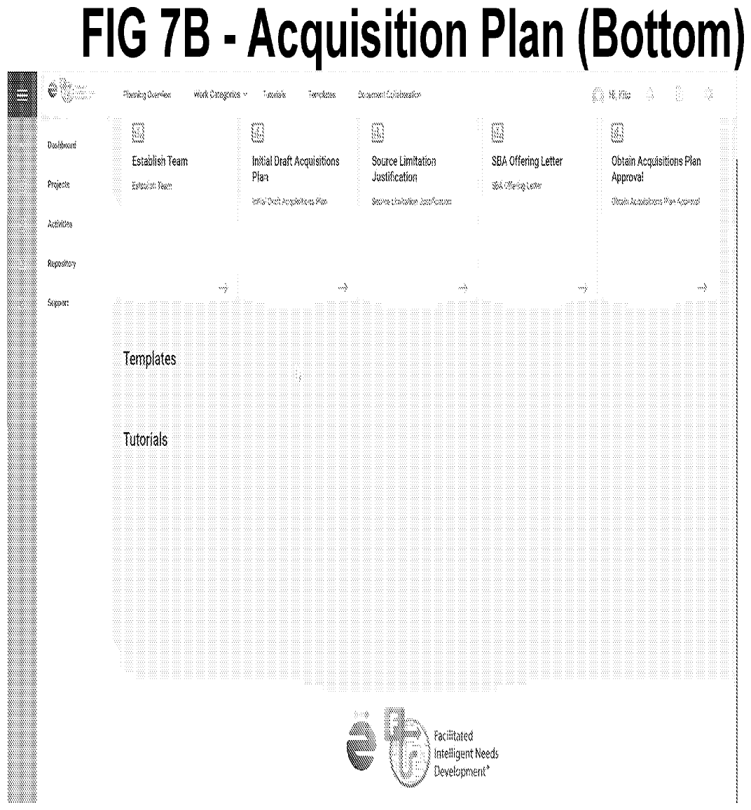

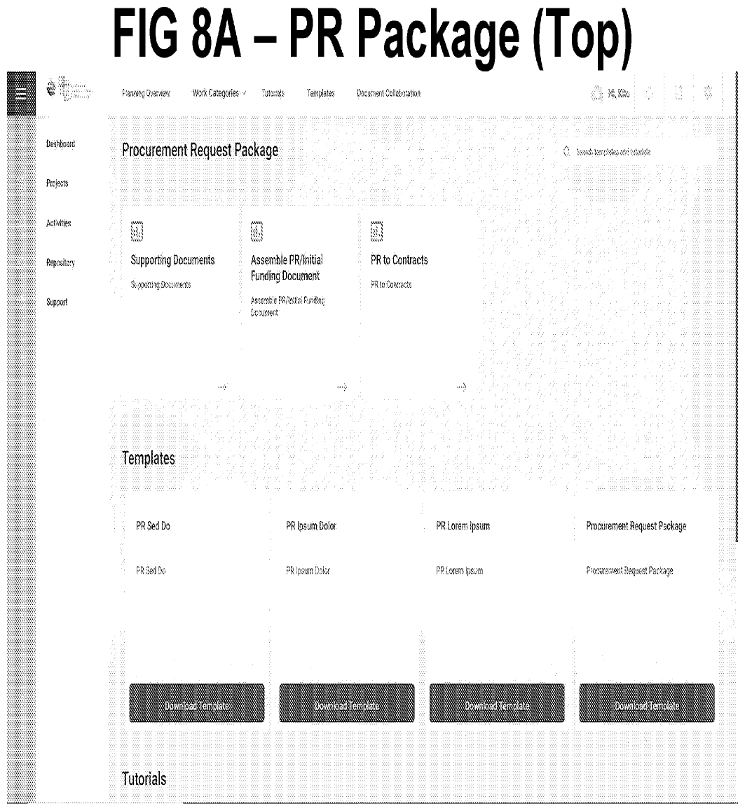

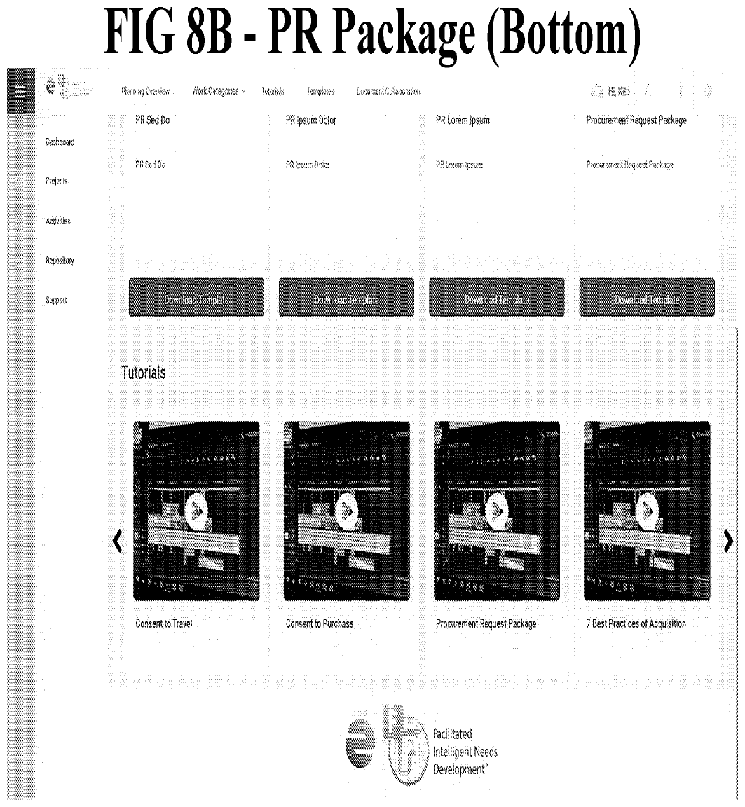

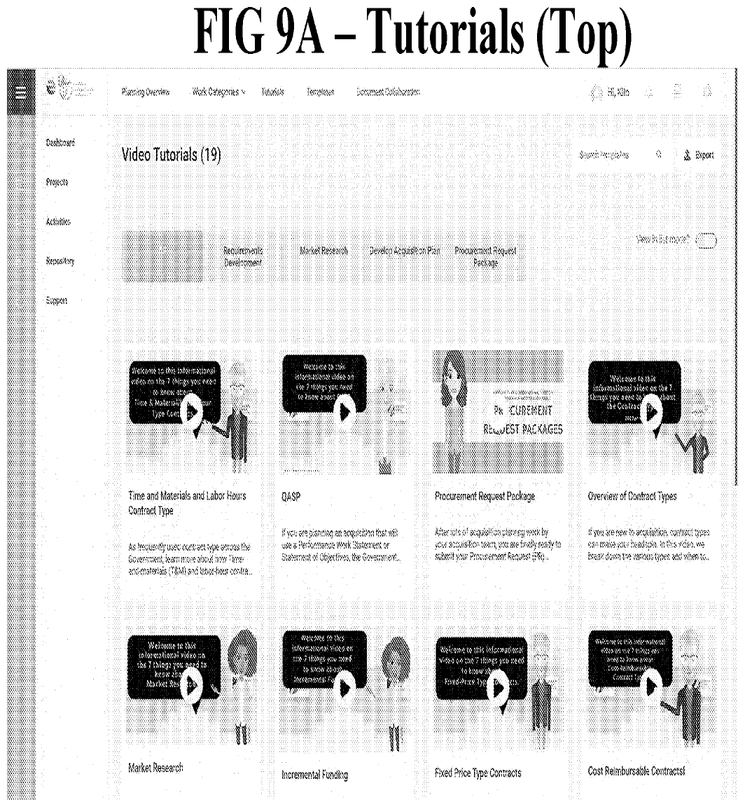

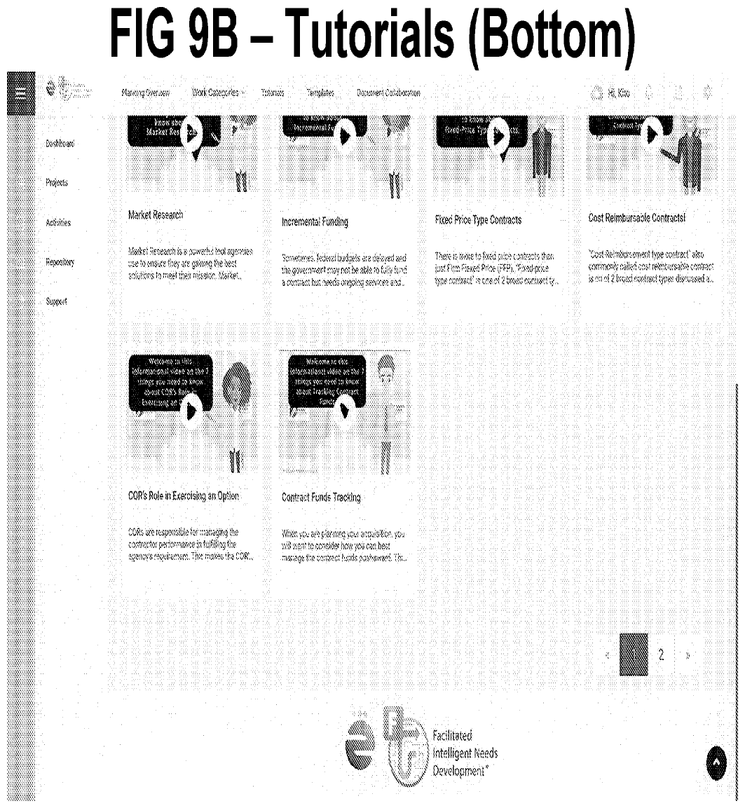

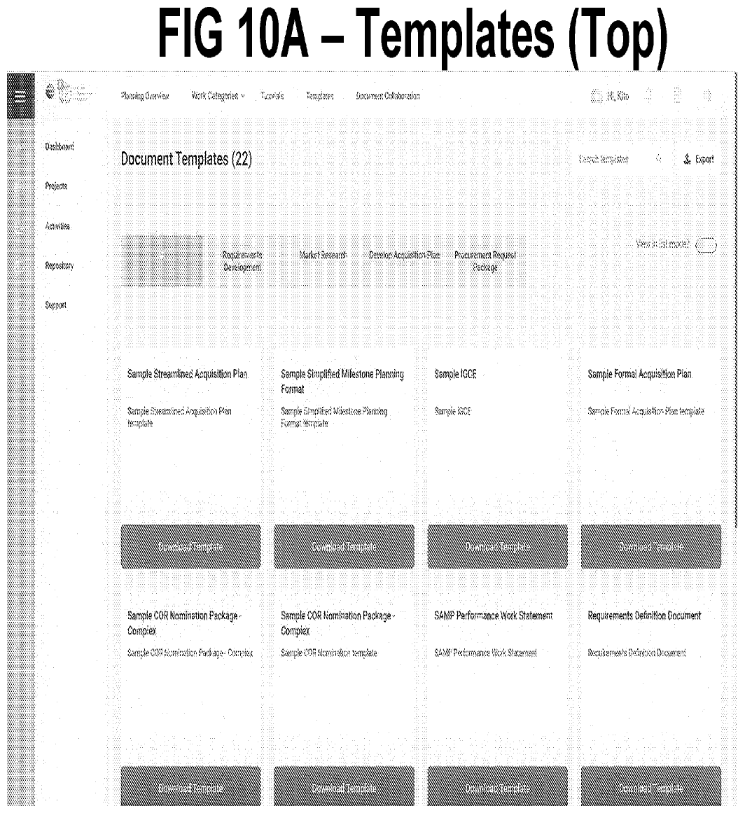

### DETAILED DESCRIPTION

The present invention is designed to provide government acquisition professionals an easy, intuitive, and effective state-of-the art means by which to plan acquisitions from requirement development through procurement requisition package submission. In addition, the present invention allows junior government acquisition professionals an opportunity to benefit from the knowledge and experience of more senior and tenured government acquisition professionals via in app workflows, process automation, templates, video tutorials, best practices, ask an expert, and a robust acquisition planning repository. Moreover, the present invention reduces the number of failed government contracts due to poor requirement development, the number of excess monies spent on poorly developed procurements that end in sustained protests or delayed awards, and identifies and increases overall efficiencies that pertain to the purchase of goods and/or services for the United States government.

In agile software development, software is designed based on user stories that communicate the role, the need, and the context for the need. The user stories are then used as the basis for design, development, and testing. The following user stories are employed to create the screen shots and processes of the present invention.

| Work Category | Title | User Story |
|---|---|---|
| Navigation | Navigate | As a system user when I login to the system, I |
| | Work | want to be able to see the following list of work |
| | Categories | category items visible from all pages within the |
| | menu | app: |
| | | 1. Requirements Development |
| | | 2. Market Research |
| | | 3. Acquisition Planning |
| | | 4. Procurement Request Package |
| | | so that I can easily access all deliverables and/ |
| | | Or functionality related to each work category. |
| Navigation | Add left pane | As a system user when I login to the system, I |
| | menu | want to be able to see the following list of top- |
| | | level menu items visible from all pages within the |
| | | app: |
| | | 1. Dashboard |
| | | 2. Projects |
| | | 3. Activities |
| | | 4. Repository |
| | | 5. Reports |
| | | 6. Support |
| | | so that I can easily access all work and/or |
| | | functionality related to each menu item. |
| Planning | Display | As a Requirements Owner (RO) with limited |
| Overview | Acquisition | experience in acquisition planning, I want to be |
| | Planning | able to read definition of acquisition planning, |
| | Overview | access templates for acquisition planning, and |
| | | view video tutorials on subjects related to |
| | | acquisition planning. |
| Requirements | Display | As a RO when I login to the system and click on |
| Development | Requirements | the Requirements Development work category, I |
| | Development | am taken to the Requirement Development home |
| | page | page which includes the following items: |
| | | 1. Requirements Definition and Acquisition |
| | | Needs Statement |
| | | 2. Cost Estimate |
| | | 3. Evaluation Criteria and Planning |
| | | so that I can easily create these activities, access |
| | | templates, and video tutorials related to |
| | | requirements development from one location. |
| Market Research | Display | As a RO when I login to the system and click on |
| | Market | the Market Research work category, I am taken to |
| | Research page | the Market Research home page which includes |
| | | the following items: |
| | | 1. Plan Market Research |
| | | 2. Conduct Market Research |
| | | 3. Market Research Engagements |
| | | 4. Pre-Solicitation Conference |
| | | 5. Request for Information (RFI)/Sources |
| | | Sought |
| | | 6. Draft Solicitation |
| | | 7. Analyze MR Findings |
| | | 8. Prepare Market Research Report |
| | | so that I can easily create these activities, access |
| | | templates, and video tutorials related to Market |
| | | Research from one location. |
| Acquisition Plan | Display | As a RO when I login to the system and click on |
| | Acquisition | the Acquisition Plan work category, I am taken to |
| | Plan page | the contract modifications page which includes the |
| | | following items: |
| | | 1. Establish Team |
| | | 2. Initial Draft Acquisition Plan |
| | | 3. Source Limitation Justification |
| | | 4. SBA Offering Letter |
| | | 5. Obtain Acquisition Plan Approval |
| | | so that I can easily create these activities, access |
| | | templates, and video tutorials related to |
| | | Acquisition Plan from one location. |
| Procurement | Display | As a RO when I login to the system and click the |
| Request Package | Procurement | Procurement Request Package work category, I am |
| | Request | able to perform the following: |
| | Package page | 1. Supporting Documents |
| | | 2. Assemble Procurement Request (PR)/Initial |
| | | Funding Document |
| | | 3. PR to Contracts |
| | | so that I can easily create these activities, access |
| | | templates, and video tutorials related to |
| | | Procurement Request Package from one location. |
| Tutorials | Display | As a system user when I login to the system and |
| | Tutorials page | click the Tutorials menu item, I am taken to the |
| | | Tutorials home page which includes: |
| | | 1. A list of all existing video tutorials in the |
| | | system sorted by title |
| | | 2. Ability to filter by work category |
| | | 3. Options to view and download tutorials |
| | | 4. A search bar which allows me to search |
| | | for tutorials |
| | | so that I can easily access tutorials from one |
| | | location. |
| Templates | Display | As a system user when I login to the system and |
| | Templates | click the Templates menu item, I am taken to the |
| | page | Template home page which includes: |
| | | 1. A list of all existing templates in the |
| | | system |
| | | 2. Ability to filter by work category |
| | | 3. Options to view and download templates |
| | | 4. A search bar which allows me to search |
| | | for templates |
| | | so that I can easily access templates from one |
| | | location. |
| Document | Display | As a system user when I login to the system and |
| Collaboration | Document | click the Document Collaboration menu item, I am |
| | Collaboration | taken to the Document Collaboration page which |
| | page | includes: |
| | | 5. A list of all my existing documents in the |
| | | system |
| | | 6. Ability to sort by name, document type, |
| | | date last modified, user who last modified |
| | | 7. Options to edit, view, share, download, |
| | | and delete documents |
| | | 8. Ability to attach files to my existing |
| | | projects or activities |
| | | 9. A search bar which allows me to search |
| | | for documents that I have access to |
| | | so that I can easily access documents from one |
| | | location and collaborate with my team members |
| | | on documents. |
| Dashboard | Add | As an acquisition professional (RO, CO, CS, COR, |
| | Dashboard | PM, Program Director, Procurement Executive or |
| | views | other role) when I login to the system and/or click |
| | | on the Dashboard option in the left pane or the |
| | | FIND logo at the top left of any page, I am taken |
| | | to a dashboard page which includes the below |
| | | metrics and/or key performance indicators: |
| | | 1. Average Time to Completion |
| | | 2. # of Active Projects |
| | | 3. Total Dollar Amount for Active Projects |
| | | 4. # of Projects with Expiring Funds |
| | | 5. Budget Progress for the funding status of |
| | | committed, reserved, budgeted, unfunded |
| | | 6. Activity Status Board that shows my activities |
| | | and action items based on status: to-do, in- |
| | | progress, manager-review or complete |
| | | 7. Approval status |
| | | 8. Projects by work category |
| | | 9. Average time to completion for the work |
| | | categories |
| | | 10. Project listing |
| | | 11. Workload Tracking by Project POC |
| | | so that I can know at a glance which issues need |
| | | my immediate attention. |
| Projects | Display | As an acquisitions professional (RO, CO, CS, |
| | Projects page | COR, PM, Program Director, Procurement |
| | | Executive or other role) when I login to the system |
| | | and click the Projects menu item, I am taken to the |
| | | project home page which includes: |
| | | 1. a list of all existing projects, project identifier, |
| | | project title, Point of Contact (POC), estimated |
| | | value, creation date, requested award date, and |
| | | status for each project in the system prioritized |
| | | by Request Award Date with the ability to |
| | | filter by My Projects, My Teams Projects, or |
| | | all Projects under my supervision |
| | | 2. options to create, view, edit, and delete |
| | | projects |
| | | so that I can easily access project information and |
| | | manage project activities based on my role. |
| Projects | Create a | As a RO after clicking the Project button on the |
| | project | left menu pane or clicking on the create project |
| | | button on the proj ect home page, I want to enter |
| | | the critical Project information that should be |
| | | shared among all acquisition team members: |
| | | Project Title* |
| | | Project Identifier* |
| | | Recommended Contract Type |
| | | Work Category Status* |
| | | Creation Date (assigned by system but editable)* |
| | | Requested Award Date* |
| | | PR to Contracts Date |
| | | Estimated Value* |
| | | Funding Status* |
| | | Program Office* |
| | | POC* |
| | | Sponsor |
| | | NAICS Code and Description |
| | | Product Service Code (PSC) |
| | | Description |
| | | Identification of the Acquisition Team |
| | | Requirements Owner* |
| | | Contracting Officer* |
| | | Contracting Officer’s Representative |
| | | Program/Project Manager |
| | | Contract Specialist |
| | | Assigned Support Contractor |
| | | Additional teammates |
| | | *Indicates required fields so project can be saved |
| | | so that I can track and monitor all of the important |
| | | information related to the creation and submission |
| | | of my procurement request project. |
| Activity | Display | As a RO when I login to the system and click the |
| | Activities page | Activities menu item, I am taken to the Activity |
| | | home page which includes: |
| | | 1. a list of all existing activities in the system |
| | | sorted by project and filterable by My |
| | | Projects, My Teams Projects, or all Projects |
| | | under my supervision |
| | | 2. options to create, view, edit, and delete |
| | | activities |
| | | 3. helpful links |
| | | 4. activity video tutorials |
| | | 5. activity document templates |
| | | so that I can easily access activity information and |
| | | manage all of my activities from one location. |
| Activity | Create an | As a RO after clicking the create activity button on |
| | Activity | the Activity home page, I am able to enter the |
| | | below information while creating an Activity: |
| | | Project Title* |
| | | Project Identifier* |
| | | Activity Title* |
| | | Activity Type (dropdown list by work |
| | | category that then shows activities within the |
| | | work category) * |
| | | Work Status Category* |
| | | Priority* |
| | | Assign To |
| | | Status |
| | | Track Completion and Configure |
| | | Notifications (Optional) |
| | | if Scheduled Date or Actual Receipt Date are |
| | | filled in, select Schedule Notification to |
| | | setup notification to the project team |
| | | members |
| | | Attachment files to the activity |
| | | Create Action Items for the Activity |
| | | so that I can track and monitor all of the important |
| | | activities related to the creation and submission of |
| | | my procurement request package (project). |
| Activity | Activity Types | As a RO, when creating an activity, I want to be |
| | | able to choose from the below types of Activities |
| | | within the four Work Categories: |
| | | 1. Requirements Development |
| | | Acquisition Needs Statement |
| | | Cost Estimate |
| | | Eval Criteria/Plan |
| | | 2. Market Research work category |
| | | Plan Market Research |
| | | Conduct Market Research |
| | | MR Engagements |
| | | Pre-solicitation Conference |
| | | RFI/Sources Sought |
| | | Draft Request for Quote/Request for |
| | | Proposal (RFX) |
| | | Analyze MR Findings |
| | | Prepare Market Research Report |
| | | 3. Develop Acquisition Plan work category |
| | | Planning Team |
| | | Initial Draft Acquisition Plan |
| | | Source Limitation Justification |
| | | SB A Offering Letter |
| | | Obtain Acquisition Plan Approval |
| | | Establish Team |
| | | 4. Procurement Request Package |
| | | Additional Supporting Documents |
| | | Assemble PR/Initial Funding Document |
| | | Process PR to Contracts |
| | | so that I can track and monitor all of the important |
| | | activities related to the creation and submission of |
| | | my procurement request package (project). |
| Requirements | Acquisition | As a RO when I create, edit or update the |
| Development | Needs | Acquisition Needs Statement activity, I want the |
| | Statement | system to: |
| | Activity | Guide me through the Steps Necessary to |
| | | Complete the Activity |
| | | Suggest Work Products: Supporting |
| | | Documentation |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Acquisition Needs Statement activity |
| | | includes all the required information for the |
| | | Acquisition Team to perform market research and |
| | | plan acquisition as well as required information for |
| | | Contracting Officer’s execution of the eventual |
| | | Procurement Request Package. I want the system |
| | | to facilitate development of the Acquisition Needs |
| | | Statement in an agile method that allows high |
| | | amount of collaboration based on the intended |
| | | objectives and enables prioritization of the |
| | | acquisition needs so the Requirements |
| | | Development process results in high quality |
| | | expression of the Government’s needs. I want the |
| | | system to facilitate the Requirements Development |
| | | process to make it so simple and organized that |
| | | ROs are not tempted to just cut and paste from the |
| | | last, outdated procurement. |
| Requirements | Cost Estimate | As a RO when I create, edit or update the Cost |
| Development | Activity | Estimate activity, I want the system to: |
| | | Guide me through the Steps Necessary to |
| | | Complete the Activity |
| | | Suggest Work Products: Supporting |
| | | Documentation |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Cost Estimate activity includes all the |
| | | required information for the Acquisition Team to |
| | | plan acquisition as well as required information for |
| | | Contracting Officer’s execution of the eventual |
| | | Procurement Request Package. I want the system |
| | | to facilitate development of the Cost Estimate so |
| | | that it is accurate with the current market |
| | | conditions and allows collaboration based on the |
| | | intended objectives and prioritization of the |
| | | acquisition needs so the Requirements |
| | | Development process results in realistic cost |
| | | estimate for the Government’s needs. I want the |
| | | system to facilitate the Cost Estimate process so |
| | | that I request the appropriate amount of funding to |
| | | allow eventual award of the contract. |
| Requirements | Evaluation | As a RO when I create, edit or update the |
| Development | Criteria and | Evaluation Criteria and Plan activity, I want the |
| | Plan Activity | system to: |
| | | Guide me through the Steps Necessary to |
| | | Complete the Activity |
| | | Suggest Work Products: Supporting |
| | | Documentation |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Evaluation Criteria and Plan activity |
| | | includes all the required information for the |
| | | Acquisition Team to plan the acquisition as well as |
| | | required information for Contracting Officer’s |
| | | execution of the eventual Procurement Request |
| | | Package. I want the system to facilitate |
| | | development of the Evaluation Criteria and Plan in |
| | | an agile method that allows high amount of |
| | | collaboration based on the intended objectives and |
| | | enables prioritization of the evaluation criteria, so |
| | | the Evaluation of the proposals allows the |
| | | Government to differentiate those proposals most |
| | | likely to meet and exceed the Government’s |
| | | objectives and acquisition needs at a reasonable |
| | | cost. I want the system to facilitate the Evaluation |
| | | Criteria and Planning process to ensure that the |
| | | Government requests information in the proposals |
| | | that is useful in the evaluation and distinguishes |
| | | the best value for the Government. |
| Market Research | Plan Market | As a RO when I create, edit or update the Plan |
| | Research | Market Research activity, I want the system to: |
| | Activity | Guide me through the Steps Necessary to |
| | | Complete the Activity factoring in |
| | | consideration of FAR 8 Required Sources |
| | | and the need for a written Market Research |
| | | Plan if complex planning |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Plan Market Research activity includes |
| | | all the required information for the Acquisition |
| | | Team to perform market research and plan |
| | | acquisition as well as required information for |
| | | Contracting Officer’s execution of the eventual |
| | | Procurement Request Package. |
| Market Research | Conduct | As a RO when I create, edit or update the Conduct |
| | Market | Market Research activity, I want the system to: |
| | Research | Guide me through the Steps Necessary to |
| | Activity | Complete the Activity |
| | | Facilitate the capture of the Market |
| | | Research Findings |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Conduct Market Research activity |
| | | includes all the required information for the |
| | | Acquisition Team to plan acquisition as well as |
| | | required information for Contracting Officer’s |
| | | execution of the eventual Procurement Request |
| | | Package. I want the system to facilitate the |
| | | Conduct Market Research process to make users |
| | | aware of various methods to research the market |
| | | that will inform the acquisition strategy of current |
| | | market conditions and solutions as well as improve |
| | | the Procurement Request Package submitted to the |
| | | Contracting Officer procurement. |
| Market Research | Market | As a RO when I create, edit or update the Market |
| | Research | Research (MR) Engagements activity, I want the |
| | Engagements | system to: |
| | Activity | Facilitate the capture of the MR |
| | | Engagement activities and findings |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my MR Engagements Activity area |
| | | consolidated for easy incorporation into the |
| | | subsequent Market Research Report. |
| Market Research | Pre-solicitation | As a RO when I create, edit or update the Pre- |
| | Conference | solicitation Conference activity, I want the system |
| | Activity | to: |
| | | Facilitate the planning and capture of the |
| | | Pre-solicitation Conference event |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Pre-solicitation Conference are |
| | | consolidated and easily incorporated into the |
| | | subsequent Market Research Report. |
| Market Research | Request for | As a RO when I create, edit or update the Request |
| | Information/ | for Information (RFI)/Sources Sought activity, I |
| | Sources | want the system to: |
| | Sought | Facilitate the capture of the RFI/Sources |
| | Activity | Sought responses |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my RFI/Sources Sought responses are |
| | | consolidated and easily incorporated into the |
| | | subsequent Market Research Report. I want to |
| | | tutorials to help me understand when I should use |
| | | a broader RFI versus a sources sought. |
| Market Research | Draft Request | As a RO when I create, edit or update the Draft |
| | for | Request for Quote/Request for Proposal (RFX) |
| | Quote/Request | activity, I want the system to: |
| | for Proposal | Facilitate the planning for and capture of |
| | (RFX) | the Draft Request for Quote/Request for |
| | Activity | Proposal (RFX) responses |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Draft Request for Quote/Request for |
| | | Proposal (RFX) responses are consolidated and |
| | | easily incorporated into the subsequent Market |
| | | Research Report and inform our acquisition |
| | | strategy. |
| Market Research | Analyze | As a RO when I create, edit or update the Analyze |
| | Market | Market Research (MR) Findings activity, I want |
| | Research | the system to: |
| | Findings | Facilitate the Analysis of MR Findings |
| | Activity | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my MR Analysis Activity is consolidated |
| | | for easy incorporation into the subsequent Market |
| | | Research Report and inform our acquisition |
| | | strategy. |
| Market Research | Prepare | As a RO when I create, edit or update the Prepare |
| | Market | Market Research Report (MRR) activity, I want |
| | Research | the system to: |
| | Report | Guide me through the Steps Necessary to |
| | Activity | Complete the Activity |
| | | Suggest Work Products |
| | | Allow me to Track Completion and |
| | | Configure Notifications for the acquisition |
| | | team |
| | | Allow me to attach documents related to |
| | | the Activity |
| | | Allow me to submit and track the attached |
| | | Market Research Report to my manager for |
| | | approval |
| | | Allow me to create Action Items related to |
| | | the Activity |
| | | Provide links to Resources related to this |
| | | activity to include Helpful Links, Video |
| | | Tutorials, Document Templates |
| | | so that my Prepare Market Research Report |
| | | activity includes all the required information for |
| | | the Acquisition Team to plan acquisition as well as |
| | | required information for Contracting Officer’s |
| | | execution of the eventual Procurement Request |
| | | Package. I want the system to facilitate the |
| | | workflow of the Market Research Report so I can |
| | | see the status of approval to ensure timely review |
| | | that is consistent with the acquisition schedule. |
| Develop | Planning Team | As a RO when I create, edit or update the Planning |
| Acquisition Plan | Activity | Team activity, I want the system to: |
| | | Recommend Inputs from the Requirements |
| | | Development, Market Research and other |
| | | Acquisition Plan Development Activities |
| | | Guide me through the Steps Necessary to |
| | | Complete the Activity |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Planning Team includes all the required |
| | | information for the Contracting Officer’s |
| | | execution of the eventual Procurement Request |
| | | Package. I want the system to facilitate creation |
| | | and communication with the initial team |
| | | responsible for developing the Acquisition Plan |
| | | before the larger Acquisition Team is created. |
| Develop | Initial Draft | As a RO when I create, edit or update an Initial |
| Acquisition Plan | Acquisition | Acquisition Plan activity, I want the system to: |
| | Plan Activity | Recommend Inputs from the Requirements |
| | | Development, Market Research and other |
| | | Acquisition Plan development activities, |
| | | Guide me through the Steps Necessary to |
| | | Complete the Activity, |
| | | Ask clarifying questions related to |
| | | competition and socioeconomic programs |
| | | required by the Federal Acquisition |
| | | Regulations |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Acquisition Plan includes all the |
| | | required information for the Contracting Officer’s |
| | | execution of the eventual Procurement Request |
| | | Package. I want the system to intelligently |
| | | automate the Acquisition Planning process based |
| | | on what I enter so that the planning process is |
| | | streamlined reducing time to develop the PR |
| | | package and increasing completeness an accuracy |
| | | of the package to reduce rework. |
| Develop | Source | As a RO when I create, edit or update the Source |
| Acquisition Plan | Limitation | Limitation Justification (SLJ) activity, I want the |
| | Justification | system to: |
| | Activity | Recommend Inputs from the Requirements |
| | | Development, Market Research and other |
| | | Acquisition Plan development activities |
| | | Guide me through the Steps Necessary to |
| | | Complete the Activity |
| | | Suggest Work Products |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Source Limitation Justification includes |
| | | all the required information for the Contracting |
| | | Officer’s execution of the eventual Procurement |
| | | Request Package. I want the system to |
| | | intelligently automate the Acquisition Planning |
| | | process including the decision to limit sources |
| | | based on what I enter so that the planning process |
| | | is streamlined reducing time to develop and |
| | | increasing accuracy of the package to reduce |
| | | rework. |
| Develop | Small | As a RO when I create, edit or update the SBA |
| Acquisition Plan | Business | Offering Letter activity, I want the system to: |
| | Administration | Recommend Inputs from the Requirements |
| | (SBA) | Development, Market Research and other |
| | offering Letter | Acquisition Plan development activities |
| | Activity | Guide me through the Steps Necessary to |
| | | Complete the Activity |
| | | Suggest Work Products |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my SBA Offering Letter Team includes all |
| | | the required information for the Contracting |
| | | Officer’s communication with the SBA on |
| | | directing the procurement to an 8(a) contractor. I |
| | | want the system to intelligently automate the |
| | | Acquisition Planning process based on what I |
| | | enter so that the SBA Offering Letter interchange |
| | | with the SBA is streamlined reducing time to |
| | | award the resulting directed 8(a) contract. |
| Develop | Obtain | As a RO when I create, edit or update the Obtain |
| Acquisition Plan | Acquisition | Acquisition Plan Approval activity, I want the |
| | Plan Approval | system to: |
| | Activity | Recommend Inputs from the Requirements |
| | | Development, Market Research and other |
| | | Acquisition Plan Development Activities |
| | | Guide me through the Steps Necessary to |
| | | Complete the Activity based on my |
| | | agency’s review process |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Acquisition Plan submitted for |
| | | Approval includes all the required information by |
| | | the Federal Acquisition Regulations and my |
| | | agency’s acquisition regulations. I want the |
| | | system to intelligently automate the Acquisition |
| | | Planning process based on what I enter so that my |
| | | Acquisition Plan Approval is streamlined and |
| | | requires only minimal rework. I want the system |
| | | to track the workflow of the required signatories so |
| | | that I know automatically know where the package |
| | | is in the review cycle. |
| Develop | Establish | As a RO when I create, edit or update Establish |
| Acquisition Plan | (Acquisition) | Team activity for the remainder of the |
| | Team Activity | procurement process, I want the system to: |
| | | Recommend Inputs from the Requirements |
| | | Development, Market Research and other |
| | | Acquisition Plan development activities |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that the system determines access to the Project |
| | | data based on who is identified as my Acquisition |
| | | Team. I want the system to intelligently automate |
| | | communications, notifications, and access by the |
| | | designated Acquisition Team members so that it |
| | | improves communication and collaboration while |
| | | protecting procurement sensitive data. |
| Procurement | Additional | As a RO when I create, edit or update the |
| Request Package | Supporting | Additional Supporting Documents activity, I want |
| | Documents | the system to: |
| | Activity | Recommend Inputs from the Requirements |
| | | Development, Market Research and other |
| | | Acquisition Plan Development Activities |
| | | Guide me through the Steps Necessary to |
| | | Complete the Activity based on my |
| | | agency’s review process |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Additional Supporting Documentation |
| | | submitted as part of the Procurement Request |
| | | Package for Approval includes all the required |
| | | information by my agency’s acquisition |
| | | regulations thereby reducing rework and |
| | | streamlining the procurement timeline. |
| Procurement | Assemble | As a RO when I create, edit or update the |
| Request Package | PR/Initial | Assemble PR/Initial Funding Document activity, I |
| | Funding | want the system to: |
| | Document | Recommend Inputs from the Requirements |
| | Activity | Development, Market Research and other |
| | | Acquisition Plan Development Activities |
| | | Guide me through the Steps Necessary to |
| | | Complete the Activity based on my |
| | | agency’s review process |
| | | Suggest Work Products |
| | | Determine the Next Activity required |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Provide links to Resources related to this |
| | | activity to include Helpful Links, Video |
| | | Tutorials, Document Templates |
| | | so that my Procurement Request with Initial |
| | | Funding Document is complete and provide good |
| | | information required by my agency’s acquisition |
| | | regulations thereby improving the quality, |
| | | reducing rework, and streamlining the |
| | | procurement timeline. |
| Procurement | Process PR to | As a RO when I create, edit or update the Process |
| Request Package | Contracts | PR to Contracts activity, I want the system to: |
| | Activity | Identify the Required Documents and |
| | | Recommend other Inputs from the |
| | | Requirements Development, Market |
| | | Research and other Acquisition Plan |
| | | Development Activities |
| | | Guide me through the Steps Necessary to |
| | | Complete the Activity based on my |
| | | agency’s review process |
| | | Suggest Work Products |
| | | Allow me to Track Completion and |
| | | Configure Notifications for the acquisition |
| | | team |
| | | Allow me to attach documents related to |
| | | the Activity |
| | | Allow me to create Action Items related to |
| | | the Activity |
| | | Allows me to hit a Submit PR Package so |
| | | that all of the attached documentation in the |
| | | package is uploaded into the agency’s |
| | | contract writing system or if interface to the |
| | | contract writing system is not allowed, the |
| | | PR package is submitted as an email to the |
| | | Contract intake mailbox |
| | | Provide links to Resources related to this |
| | | activity to include Helpful Links, Video |
| | | Tutorials, Document Templates |
| | | so that my Procurement Request Submitted to |
| | | Contracts includes the final version of all |
| | | documents and other files, the package is |
| | | complete, and complies with my agency’s |
| | | acquisition regulations thereby improving the |
| | | quality, reducing rework, and streamlining the |
| | | procurement timeline. I want to push a button to |
| | | submit the PR package so I know all final version |
| | | of the files are included. |
| Repository | Display | As a system user when I login to the system and |
| | Repository | click the Repository menu item, I am taken to the |
| | page | Repository home page which includes: |
| | | 1. A list of all existing repositories items in |
| | | the system prioritized by contract |
| | | requirements and work products |
| | | 2. Options to upload, download, view, and |
| | | delete repository items as well as edit |
| | | repository item meta data |
| | | so that I can easily access all documentation stored |
| | | in the system for all of my requirements/projects in |
| | | one location. |
| Repository | Repository | As a system user when I upload and/or attach a file |
| | upload | to a project, activity, action item, invoice, |
| | functionality | contractor and/or any other items, I want to open |
| | | the Repository page and see those documents |
| | | reflected there and associated with the project so |
| | | that all the project documentation is stored in a |
| | | central location and provide proper RO PR records |
| | | management. |
| Repository | Search | As a system user, I want to be able to enter text at |
| | documents in | the top of the repository for all matching and/or |
| | repository | similar lines of text and provide me a list with |
| | | links to relevant data items so that I can easily |
| | | locate and access any related information in |
| | | accordance with my permissions. |
| Support | Display | As a RO, I want to be able to submit a support |
| | Support page | request so that if the application is not performing |
| | | properly and/or I need assistance performing some |
| | | activity I can submit a request for assistance. I |
| | | want to be able to call the support line or request a |
| | | support ticket. I want access to other User |
| | | Assistance articles so that I can help myself if an |
| | | article addresses my issue. |
| Support | Display | As a system user, I want to ask an acquisition |
| | Support page | expert for help on any acquisition-related topic |
| | and select Ask | with the ability to provide my contact info, the |
| | the Experts | question, and upload files for consideration by the |
| | | expert. |
| Settings | Display | As a system user, I want to be able to access a |
| | settings/config | settings page that allows me to view my username, |
| | uration page | update my password, edit my contact information, |
| | | edit my department, and/or other settings so that |
| | | my most recent and relevant information is |
| | | available and make user-allowed adjustments to |
| | | have a better user experience. |
| Authentication | User | As a RO, Contracting Officer (CO), Contract |
| | Authentication | Specialist (CS), Contracting Officer’s |
| | | Representative (COR), Program Manager (PM), |
| | | Program Director, Procurement Executive, or any |
| | | other role, I want to be able to enter my username |
| | | and password to login to my Enlightened Solutions |
| | | FIND module so that I can perform my work |
| | | duties related to the acquisition planning for the |
| | | federal government. |
| Permissions & | Create user | As a Systems Administrator, I want to ensure that |
| Roles | permissions | different users are able to access different |
| | and roles | functionality so that each user has access to the |
| | | functionality that they need to perform the duties |
| | | required by their respective position. |
| Permissions & | Create project | As a Project POC, I want to add members to the |
| Roles | roles | Project (Acquisition Team) based on their role so |
| | | they have access to the functionality that they need |
| | | to perform the duties required by their respective |
| | | position. |
| Integration | Integration | As an Acquisition Team member, I want to be able |
| | between | to view projects and other information relevant to |
| | Enlightened | the creation of acquisition planning projects |
| | Solutions | (culminating in PR packages) that I entered in the |
| | Suite: | ES FIND module and the resulting awarded |
| | Facilitated | contracts in the ES CPI module so that I don’t |
| | Intelligent | have to enter information more than once |
| | Needs | throughout the acquisition life cycle and I have |
| | Development | access to the evolution of the acquisition need and |
| | (FIND) for | context around the acquisition strategy and |
| | acquisition | contract award. |
| | planning and | |
| | Contractor | |
| | Performance | |
| | Intelligence | |
| | (CPI) for post | |
| | award | |
| | contractor | |
| | performance | |
| | management | |
| | modules | |

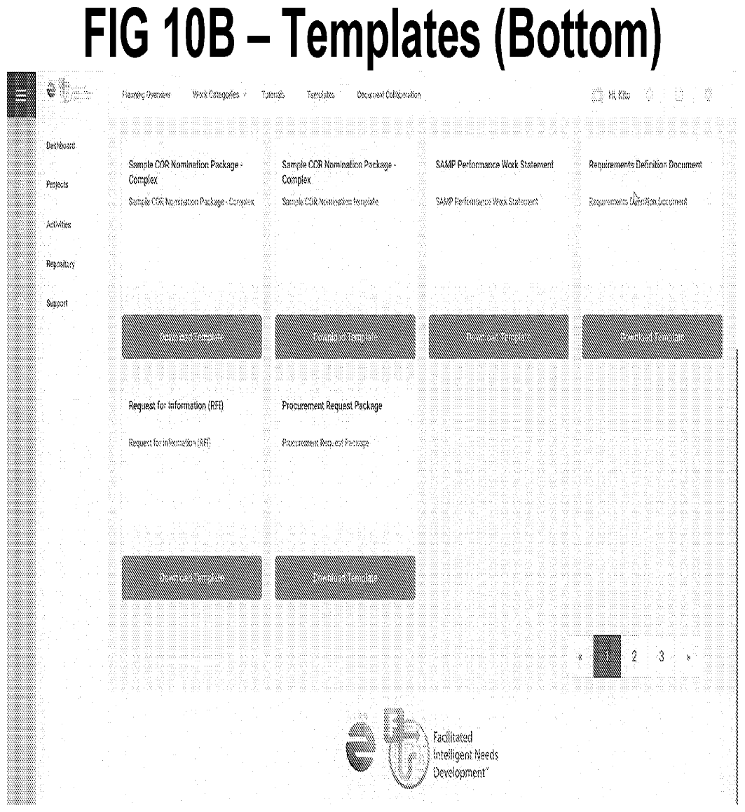

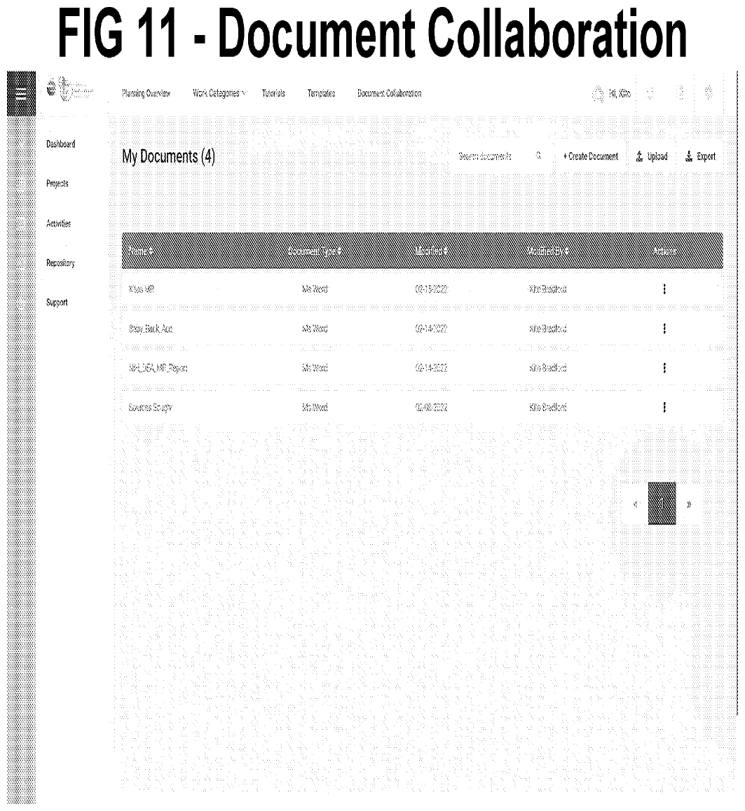

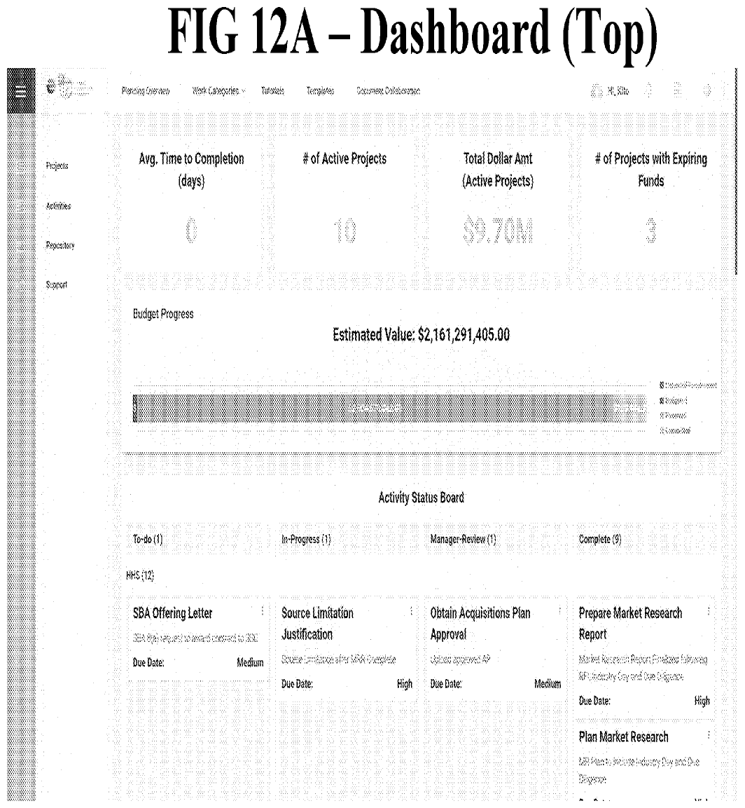

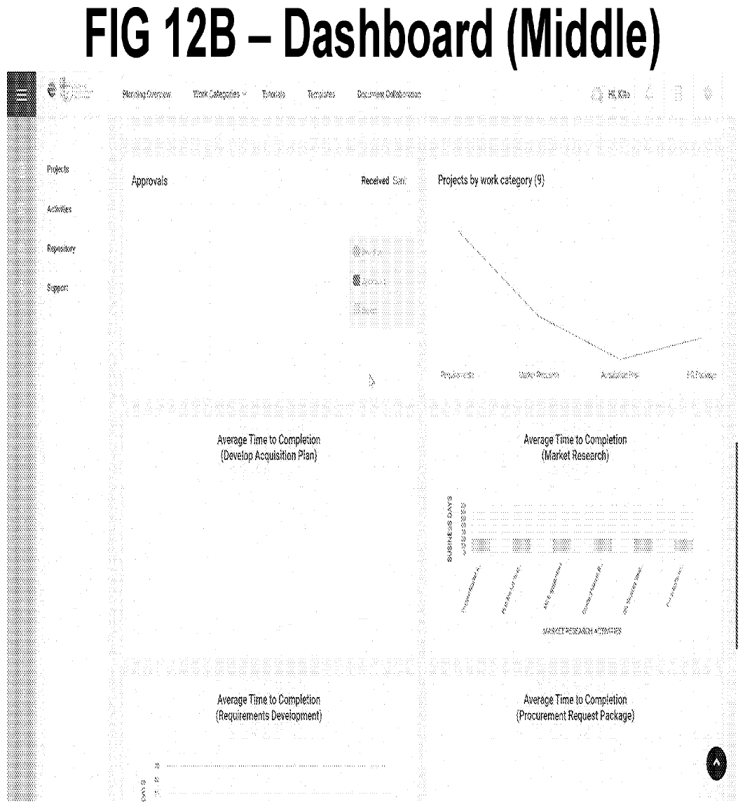

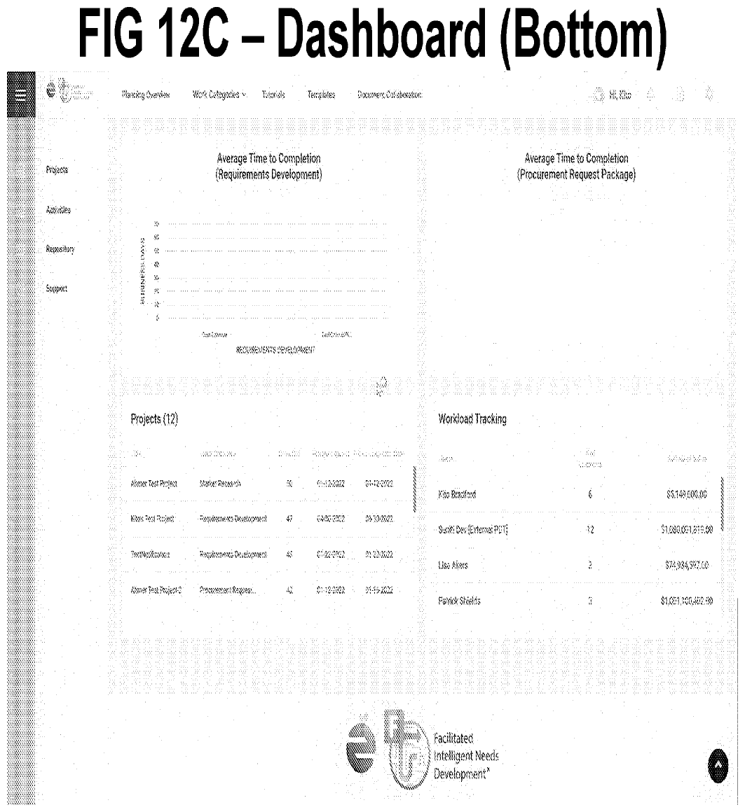

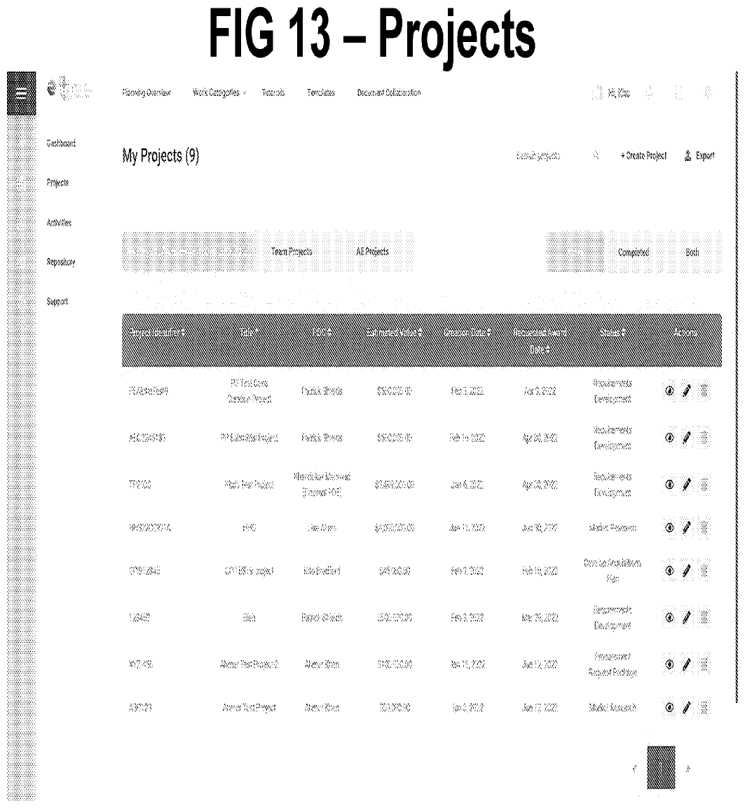

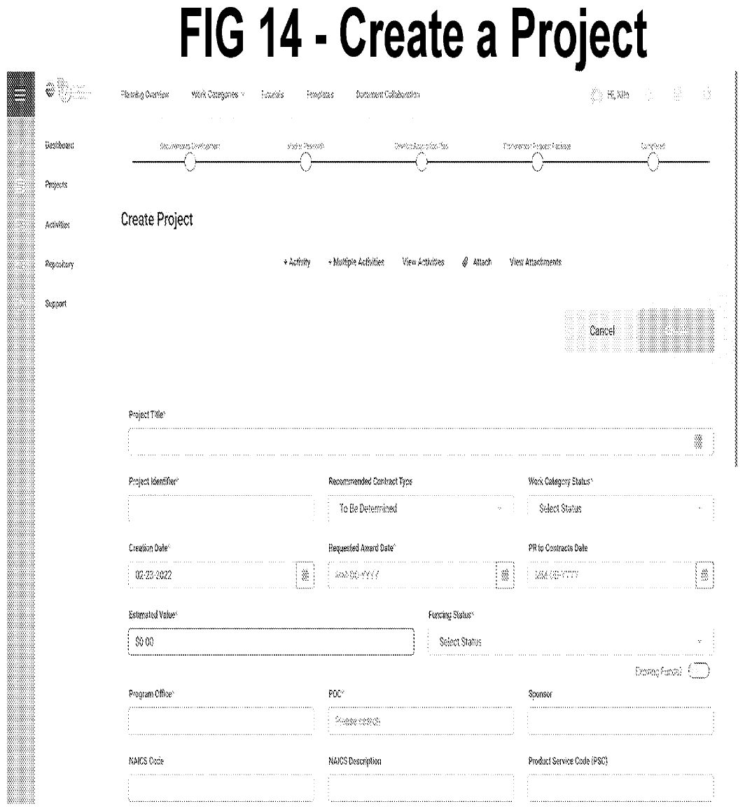

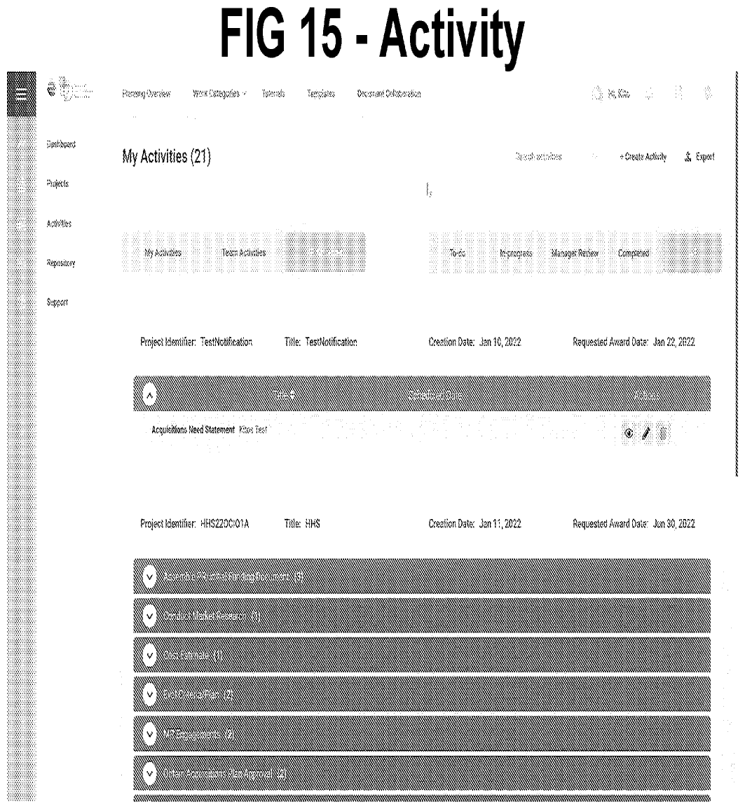

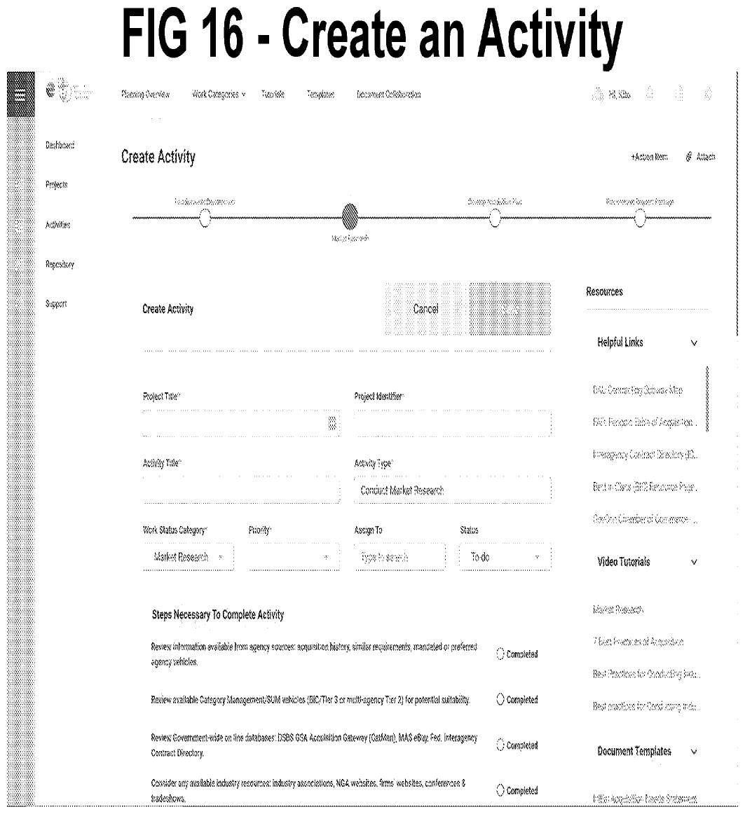

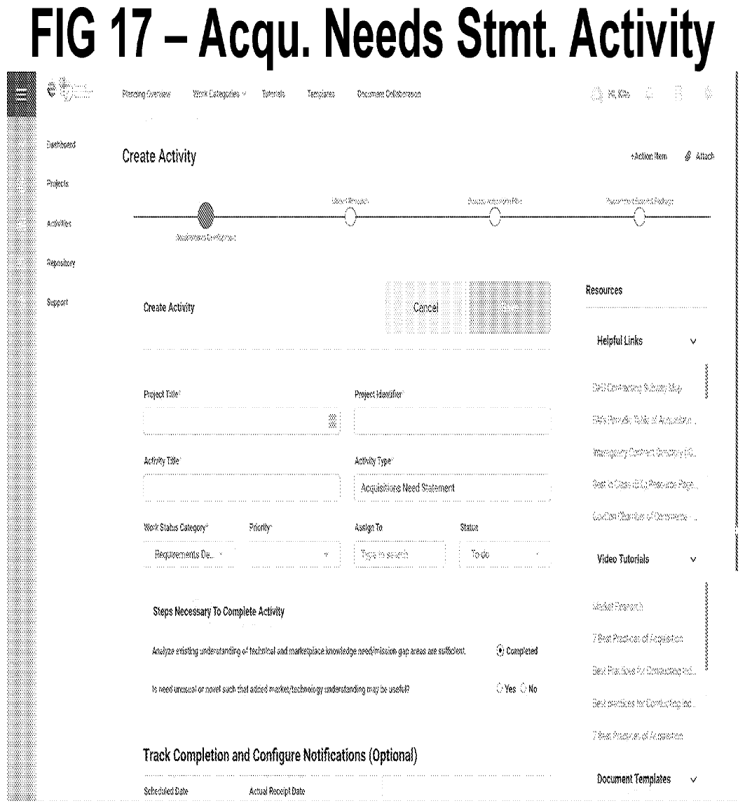

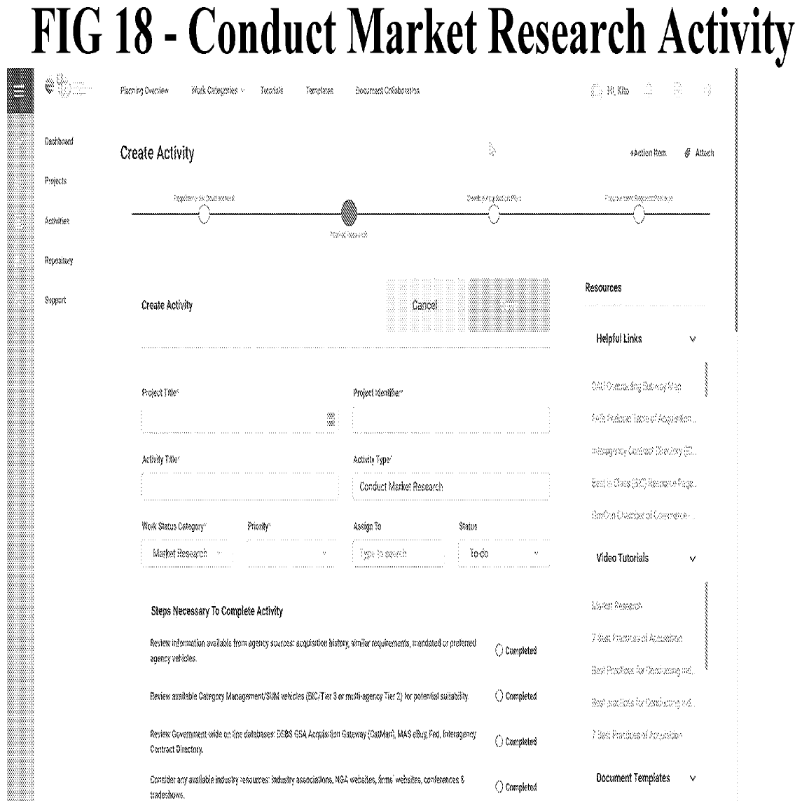

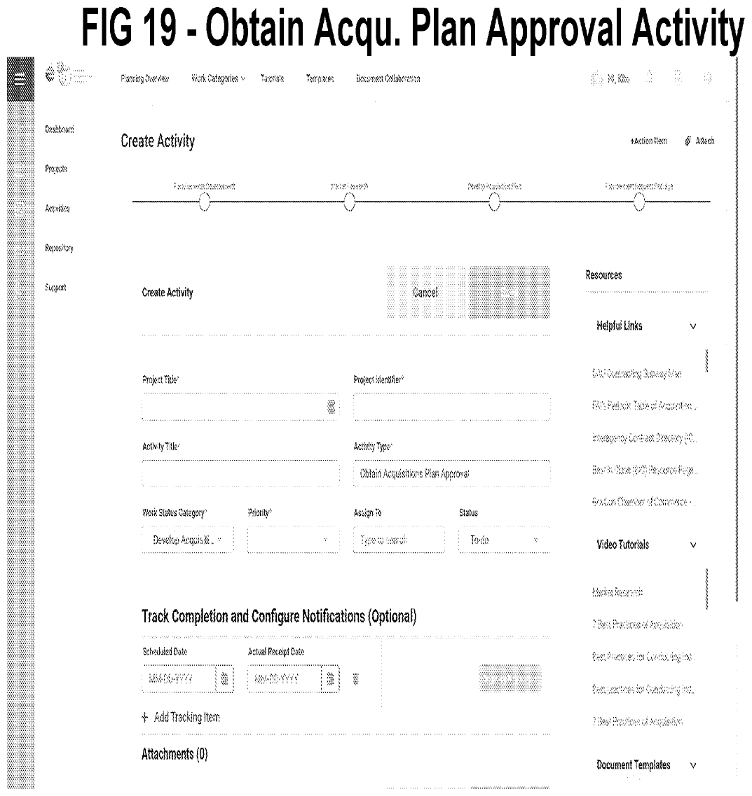

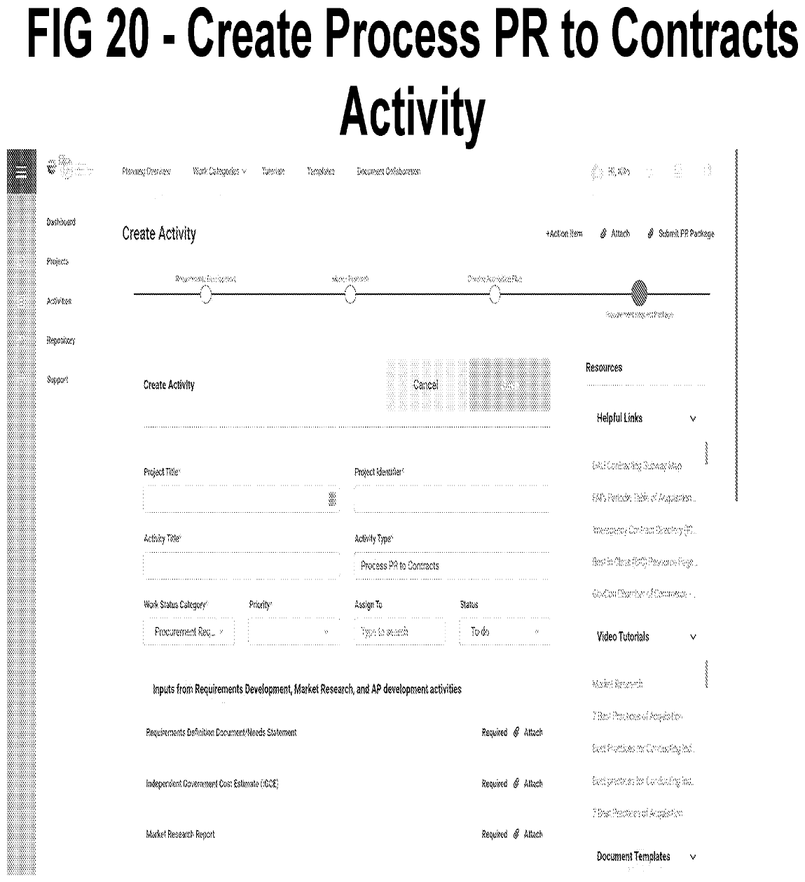

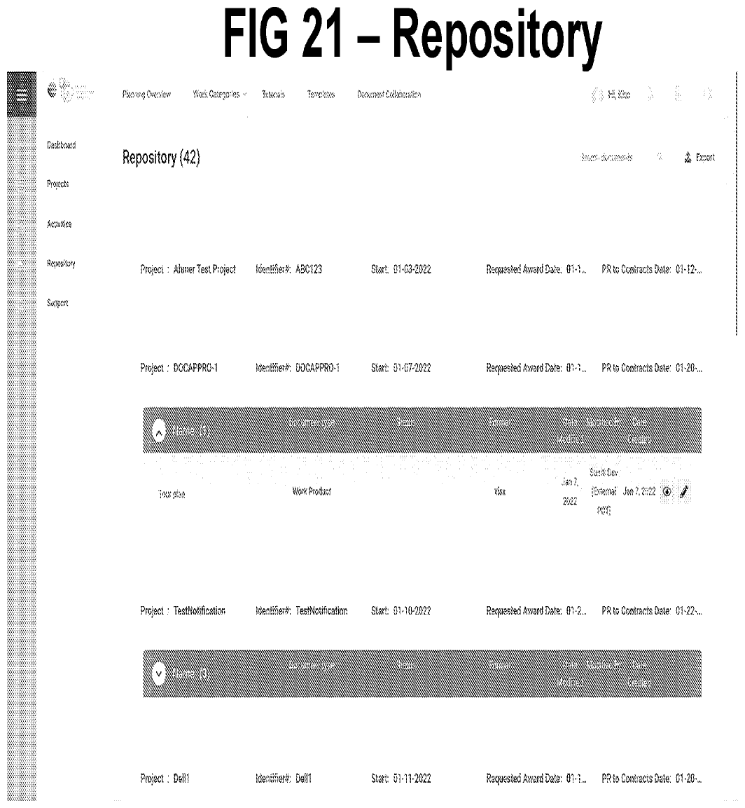

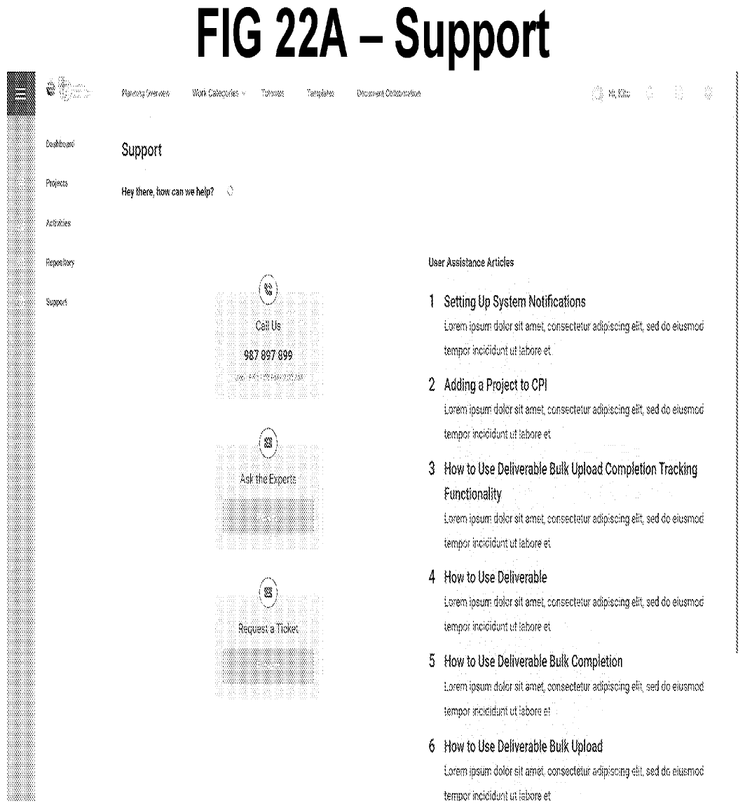

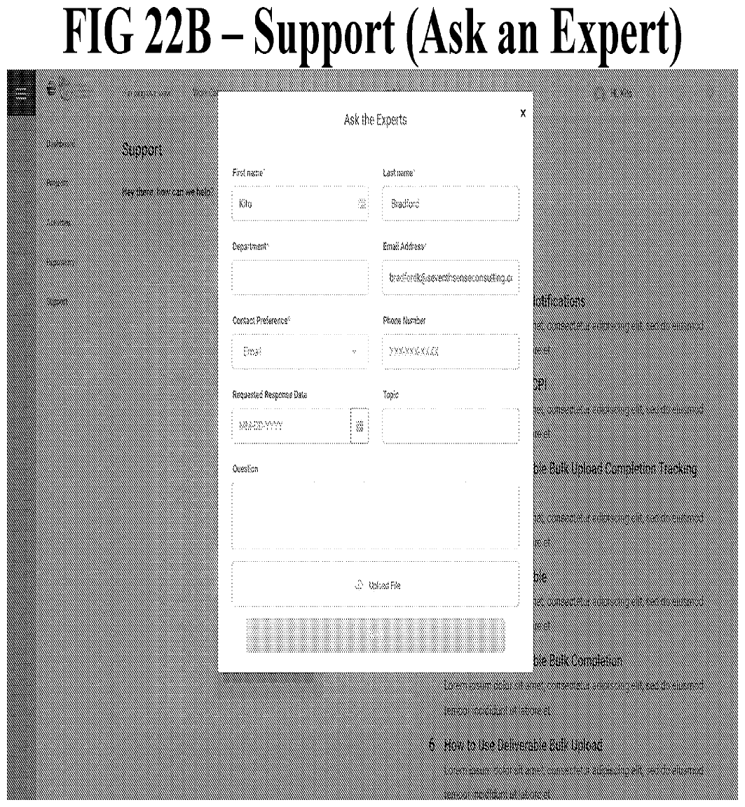

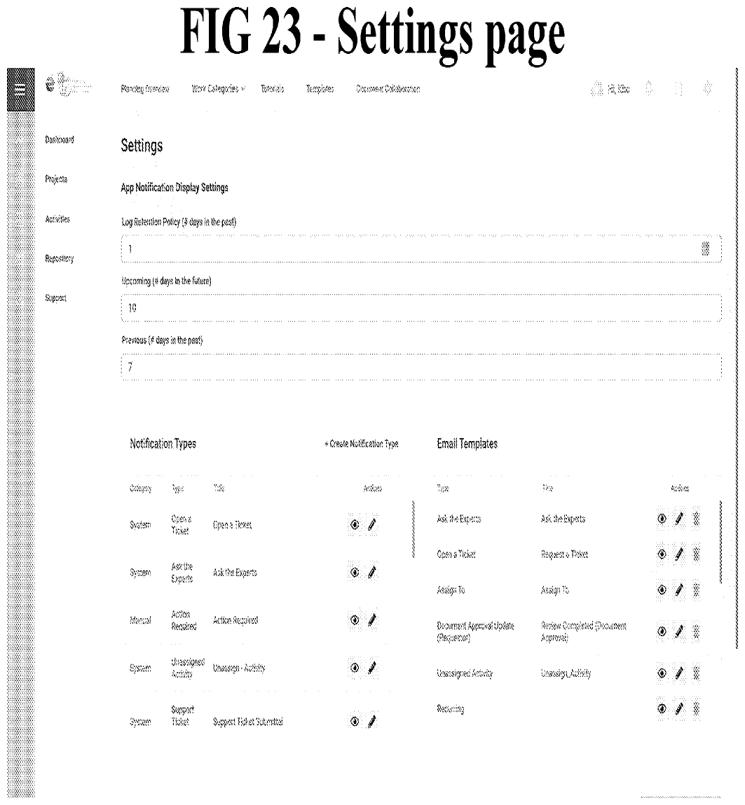

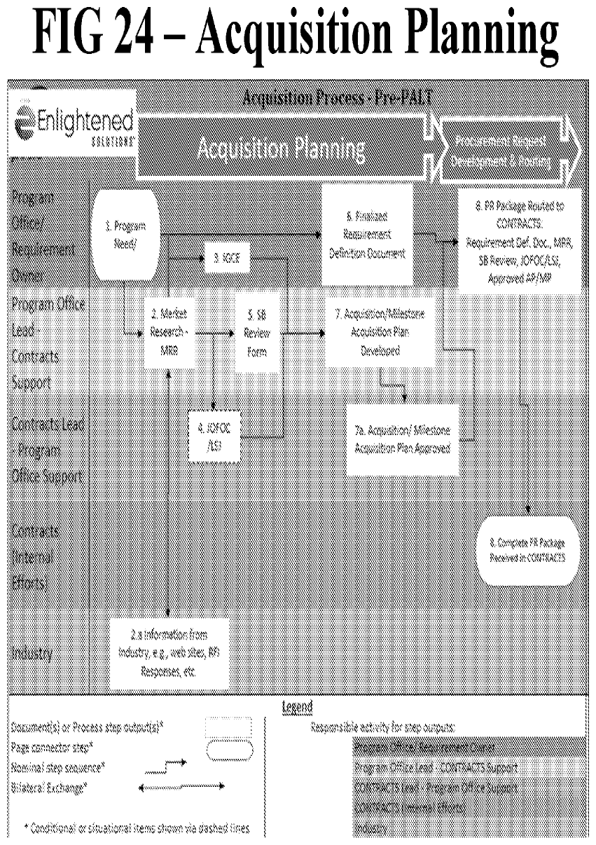

Turning to FIGS. 24-27, shown therein are the contract procurement process lifecycles in block diagram format, which are implemented in the present invention. We begin with FIG. 24. The present invention provides intelligent process automation for the procedures shown in the FIG. 24 as well as sub-procedures that are not detailed in the figure.

1. Program Need/Requirement—This represents the Program Office determination that it has a need to acquire supplies or services that are not available from AGENCY in-house sources. Most often, a program need consists of at least a basic articulation of what is needed combined with some degree of confidence that some funding can be allocated.

2. Market Research— MRR— This represents the conduct of Market Research in accordance with AGENCY POLICY on Market Research, and the fact that the output of the Market Research effort is a Market Research Report (MRR) detailing procedures, findings, analysis and conclusions reached.

2a. Information from Industry, e.g., web sites, RFI Responses, etc.—depicts the fact that Market Research processes often involve information shared with and gathered from a range of diverse types of industry sources.

3. IGCE— This step is the development of an Independent Government Cost Estimate in accordance with AGENCY POLICY on Independent Government Cost Estimate, largely supported by information in the MRR. The IGCE can help to ensure that an appropriate budget allocation is available for the requirement or lead to budget-constrained tailoring in defining the requirement. Subsequently in the process, the IGCE can provide key support to determining price reasonableness of the ultimate award.

4. JOFOC/LSJ— This conditional step represents the fact that if the MRR indicates that only one source can meet the need, then a specific formal authorization is required. These terms are “Justification for Other than Full and Open Competition” (FAR Subpart 6.3) and, for FSS orders, “Limited Source Justification” (FAR 8.405-6). The CO must be promptly consulted if the MRR indicates this situation and, if the CO agrees, the Acquisition Team prepares the appropriate sections of a FAR-compliant FIND Demo and discussion around spend planning (JOFOC) or Limited Source Justification (LSJ) and the CO processes it for approval at the appropriate level.

5. SB Review Form—This step depicts the requirement to prepare and obtain Small Business Specialist review of the AGENCY's Small Business Program Review Form, for most proposed procurement approaches. See also AGENCY POLICY on Reviews and Approvals for the parameters when this review process is required.

6. Finalized Requirement Definition Document—The output of this step will often be a Statement of Objectives (SOO), Performance Work Statement (PWS) or Statement of Work (SOW) for services—or an appropriately detailed description of a supplies requirement. It will start from the initial defined need of Step 1, be refined by MRR results, possibly re-scoped for affordability based on the IGCE, all presented in a fashion to enable industry to understand the AGENCY need and present their best solution. This will be supplemented by draft technical evaluation criteria, proposal content requirements, and award selection bases.

7. (and 7a) Acquisition/Milestone Acquisition Plan Developed—Approved—These steps represent the often involved and complex requirement to develop and document an appropriate Acquisition Plan or Milestone Acquisition Plan for any acquisition requirement, in accordance with AGENCY POLICY on Acquisition Planning. The plan developed must be informed by the MRR results, the IGCE, the results of the Small Business review and must reflect the approval or disapproval of the JOFOC/LSJ if a source limitation is proposed. All of these are germane to the acquisition approach that must be properly documented. The customer (planner, often the RO) leads the development effort with AGENCY support. The process of review and approval at the appropriate level is led by AGENCY personnel with support from planner/RO/customer personnel as necessary. For large dollar value requirements, the approval of a formal AP may also require review via an AGENCY-prescribed Acquisition Review Board (ARB).

8. PR Package Routed to CONTRACTS— This step represents the assembly of a complete PR package, which must be supported by attachment of appropriate supporting documents including the Requirement Definition Document (Step 6), MRR (Step 2), IGCE (Step 3), JOFOC/LSJ (Step 4), SB review (Step 5), and Approved AP document (Step 7). Once assembled, the PR is routed by the Program Office in the Delphi and ESC PRISM systems, via the Budget and Finance offices, to CONTRACTS. Receipt of the complete PR in CONTRACTS ends the Acquisition Planning through Procurement Request process and begins the measurement of PALT.

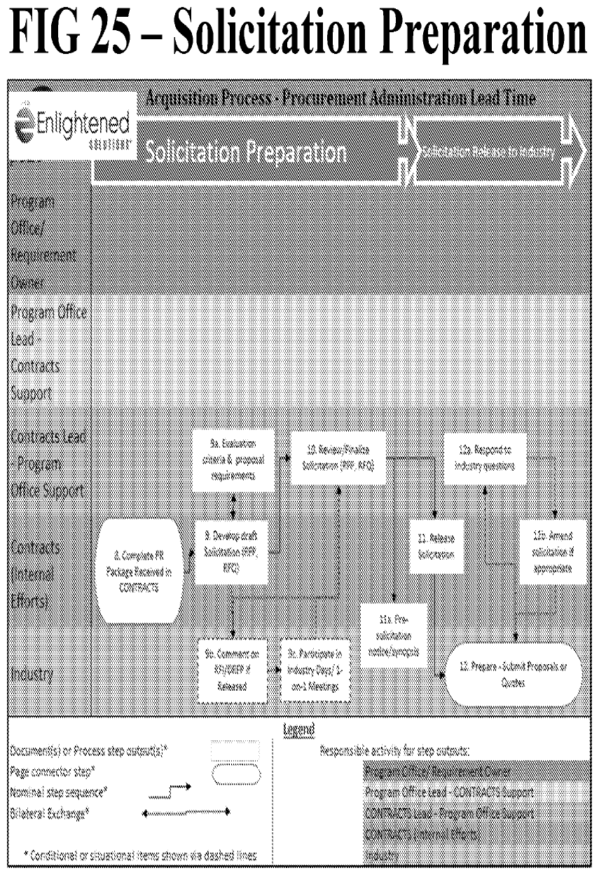

We now turn to FIG. 25.

9. Develop draft Solicitation (RFP, RFQ)— This step involves the development of the formal request to be submitted for firms to propose their respective solutions to meet the AGENCY need. This step includes interactions depicted at step 9a between CONTRACTS personnel and technical/programmatic Acquisition Team members to determine how to evaluate offers and select the awardee from among those firms that submit offers. This step may also include engagement of industry via venues such as the step 9b. publication of Requests for Information (RFIs) or Draft Requests for Proposal (DRFPs) requesting written industry feedback or per step 9c, the direct engagement via Industry Days or One-on-One meetings with firms.

10. Review/Finalize Solicitation (RFP, RFQ)— This step includes making any final changes to the solicitation document based on feedback received from steps 9a, 9b, and 9c. It also includes obtaining legal and other reviews and approval for release, as outlined in AGENCY POLICY on Reviews and Approvals.

11. Release Solicitation—This step includes either posting of the solicitation for industry offers in SAM.gov on eBuy for MAS acquisition approaches, or as appropriate for Governmentwide Acquisition Contracts (GWACs) and other multi-agency contracts.

12. Prepare—Submit Proposals or Quotes—Is the step in which industry firms prepare their responsive offers to meet the AGENCY need. Note, however, that 12a is an interactive process in which industry members can submit questions—most often regarding technical issues to increase their understanding of the AGENCY need. Also note that, as a result of issues raised by industry questions, it may become necessary to issue an amendment—step 12b—to the solicitation's terms, such as to clarify ambiguous provisions or merely to allow more time for proposal preparation.

13. Proposals or Quotes Received—This step includes the receipt of proposals or quotes and generally includes a review by CONTRACTS of each offer to ensure compliance with proposal formatting and contents constraints.

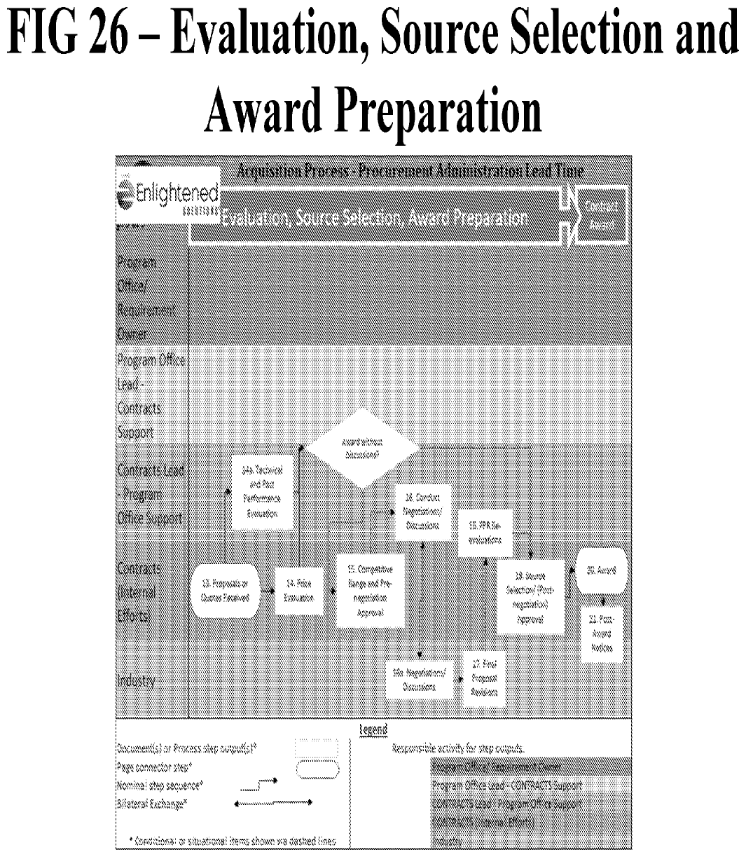

We now turn to FIG. 26.

14. (and 14a) Price Evaluation and Technical and Past Performance Evaluation—This step depicts the evaluation of offers with respect to prices offered and the solicitation's non-cost factors in support of the ultimate source selection decision.

15. Competitive Range and Pre-negotiation Approval—This step depicts the determination of a competitive range of the “most highly rated” firms and the approval of a Pre-negotiation Memorandum, if required pursuant AGENCY POLICY on Reviews and Approvals. When required, this document grants authority to enter negotiations. In some cases, where there is a fully compliant clear winning offer and the solicitation reserves the right, a decision may be made to “award without discussions.” If so, the process skips steps 15-18.

16. (and 16a) Conduct Negotiations—These depict the interaction between representatives of AGENCY and each firm in the competitive range to address deficiencies of each firm's respective offer. The AGENCY team may also opt to address relatively minor weaknesses and strengths with each firm.

17. Final Proposal Revisions—This step depicts industry responding, if they desire, to issues raised in negotiations with proposal revisions (FPRs) to improve their chances of being selected for award.

18. FPR Re-evaluations—This step depicts the re-evaluation of the firms' respective proposals as altered by the FPRs.

19. Source Selection and Post-Negotiation Approval—This step depicts the selection of the best solution to meet the AGENCY need, based on the evaluation (re-evaluation) results of each firm's submissions. This selection may be documented via a formal Source Selection Decision Document (SSDD). The SSDD serves as the most critical information supporting the Post-Negotiation Memorandum, the approval of which authorizes award of the contract pursuant to AGENCY POLICY on Reviews and Approvals.

20. Award—The CO ensures that all requirements of law, executive orders, regulations, and all other applicable procedures, including documentation, clearances and approvals have been complied with and makes the award. This ends the measurement of PALT.

21. Post-Award Notices—This step depicts the fact that there are various notices required to accompany the award of most contract actions. The exact nature of such required notices depends on factors such as dollar value.

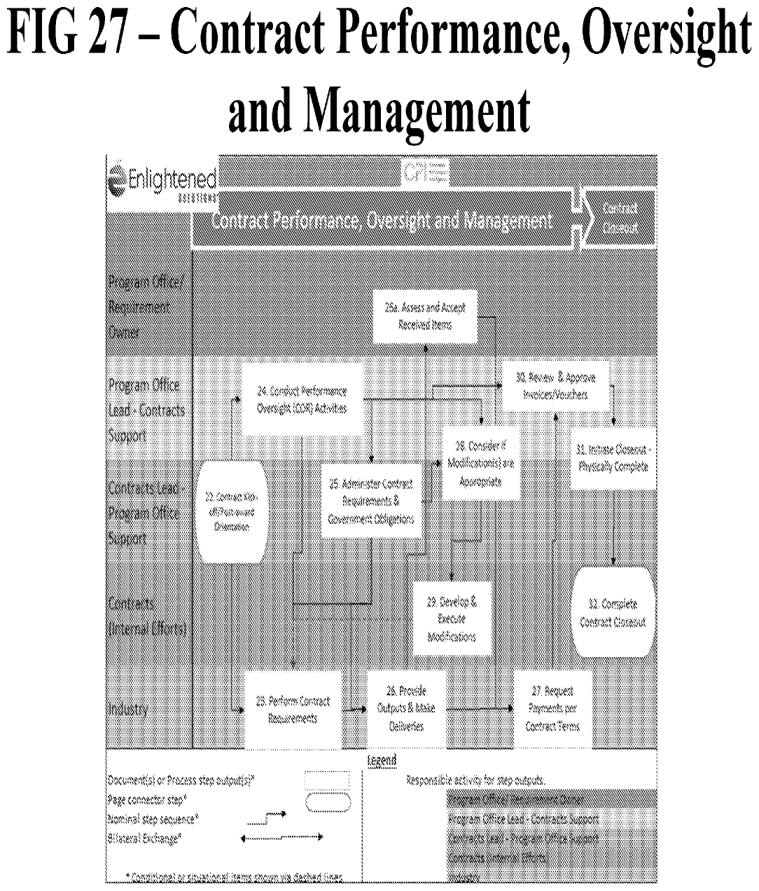

We now turn to FIG. 27.

22. Contract Kick-off/Post-award Orientation—This step could consist of a relatively informal meeting or a more formal event that orients the new Contractor to the Government's needs and requirements to foster mutual understanding of both parties and their respective key personnel. To determine meeting degree of formality, consider the magnitude and complexity of the contract, as well as the contractor's overall experience and history with the AGENCY. Minutes should be developed and issued for Post-award Orientations.

23. Perform Contract Requirements—This step depicts the Contractor's efforts to meet contract requirements, providing the required services and supplies.

24. Conduct Performance Oversight (COR) Activities—This step depicts the process of managing and overseeing the contractor's performance efforts under Step 23. It includes activities such as, but not limited to, executing the monitoring activities specified in the QASP, potentially the use of in-process inspection or test procedures for supplies, as well as other requirements that may be delineated within the Contract.

25. Administer Contract Requirements—This step includes the efforts and processes to meet the Government's obligations under a contract, such as timely provision and management of GFE/GFP/GFI, ensuring access to Government facilities and systems when warranted and as necessary for Contractor personnel, receipt, analysis, approval and timely payment of contractor invoices, plus conduct of contract closeout. This step, the Step 24 Performance Oversight Activities and the Step 26 Assessment and Acceptance of Received Items are closely intertwined and sometimes are considered as a single category of all those Government activities occurring from the point of award through contract closeout.

26. Provide Outputs and Make Deliveries—This step includes the presentation/proffering of contract deliverable requirements, such as required reports of results or delivery of supplies as being compliant with contract requirements and objectives, for acceptance by the Government.

26a. Assess and Accept Received Items—This step includes the review of all services, reports of accomplishments, and pre-acceptance inspection and test, as appropriate, of supplies upon delivery.

27. Request Payments per Contract Terms—This step includes electronic or other format requests for payment (invoices or vouchers), based on periodic entitlement or acceptance of supplies delivered/services performed.

28. Consider if Modification(s) are Appropriate—Modifications to a contract may arise for various reasons and may be proposed by the Contractor, determined appropriate by the Government to obtain to improve or ensure contract objectives are achieved, or contemplated by contract terms, such as funding increments or option exercises. If a modification is deemed appropriate, a PR package would be generated and processed to contracts per Steps 6-8, and potentially Step 4. The Contract Modification Consideration Process is included in FIG. 20.

29. Develop and Execute Modifications—This step includes pertinent steps from within Steps 9 through 20, tailored for the fact competition-specific steps are not needed, sole source negotiations with cost data support may be appropriate. Or, for modifications such as incremental funding or timely option exercises, may be issued unilaterally and without the need for solicitation or negotiation. Upon execution, Contractor performance requirements per Step 23 will usually be revised.

30. Review & Approve Invoices/Vouchers—Based on contract terms and information generated via Steps 24, 25 and 26a, billings must be approved, rejected with explanation or partially approved with explanation of any portion not approved.

31. Initiate Closeout—Physically Complete—This step follows completion by the contractor of all contractual requirements to determine physical completion.

32. Complete Closeout—This step includes the steps defined at FAR 4.804, as appropriate to the specific contract and preparation of the contract file for archiving per FAR 4.805. This is the final segment of the contract procurement process lifecycle.

What is claimed is:

1. An apparatus for performing acquisition planning in preparation for procurement and award of a contract, including a U.S. government contract, comprising:
an on-premises network to be coupled to an external network, said on-premises network including a first collaborative server having a front end application server, a first email server and a first database server, said front-end server coupled to the email server and the first database server;
an off-premises network to be coupled via said external network to the on-premises network, said off-premises network including a second collaborative server having a web server, a second email server and a second database server, said web server coupled to the second email server, and the second database server; and
said front end application server including a non-transitive computer readable media having encoded thereon instructions causing the front end application server to provide a facilitated intelligent needs development application:
said facilitated intelligent needs development application including a graphical user interface through which a user, such as a requirements owner, can manage a plurality of aspects of a government contract throughout a life cycle of a government contract, including pre-award acquisition planning to develop requirements, perform market research, develop acquisition plan, and assemble and submit procurement request package to the contracting organization.

2. The apparatus according to claim 1, wherein said facilitated intelligent needs development application:
a) enables a plurality of users to manage a plurality of government acquisition needs and procurement requests, wherein said plurality of users includes requirements owners, program managers, contracting officers, contracting officer's representatives, supervisory personnel of said contracting officers and said program managers, security officers, technical representatives, and accountants; and
b) enables supervisory personnel to review requirements, market research, acquisition plans, and procurement request packages of a plurality of government procurement requirements being managed by a plurality of other users.

3. The apparatus according to claim 1, wherein said facilitated intelligent needs development application includes an early warning system identifying one or more procurement requests at risk of delayed awards, loss of government funds, poorly developed requirements and poorly plan procurements.

4. The apparatus according to claim 1, wherein said facilitated intelligent needs development application includes an automation process for market research that guides a user through a market research process that prompts the user with questions to shape steps necessary to plan, execute and analyze the market and adequately plan the acquisition in accordance with U.S. government federal acquisition regulations.

5. The apparatus according to claim 1, wherein said facilitated intelligent needs development application includes a plurality of video tutorials and templates that are linked to one or more of a plurality of specific activities, whereby a user can select any of said plurality of video tutorials and templates to help guide the user when performing one of said plurality of specific activities.

6. The apparatus according to claim 1, wherein said facilitated intelligent needs development application provides a plurality of different user roles and allows each of said different user roles to search, filter and access files through multiple ways, including by lists of projects, activities, repositories and reports.

7. The apparatus according to claim 1, wherein said facilitated intelligent needs development application provides an ask the experts capability to enable users to ask acquisition-related questions to which said facilitated intelligent needs development application provides ad-hoc responses to new questions that have not been posed by any user or answered previously, as well as pre-programmed responses to questions previously posed or answered.

8. The apparatus according to claim 1, wherein the facilitated intelligent needs development application employs a hierarchical data structure starting with a plurality of projects, such as future procurements, each of which employs a plurality of activities, which in turn employs a plurality of action items for each activity, and a plurality of notifications related to one activity or one action item.

9. A non-transitive computer readable media having encoded thereon a plurality of instructions causing a processor to provide a facilitated intelligent needs development application that includes:
a graphical user interface through which a user, such as a requirements owner, can manage a plurality of aspects of a government project throughout a life cycle of a government procurement, including requirements development, market research, acquisition planning, and procurement request submission to contracting office;
said facilitated intelligent needs development application:
a) enabling a plurality of users to manage a plurality of government projects/procurement requests, wherein said plurality of users includes requirements owners, program managers, contracting officers, contracting officer's representatives, supervisory personnel of said contracting officers and said program managers, security officers, technical representatives, and accountants;
b) enabling one or more supervisory personnel to review quality and schedule planned of a plurality of government procurement requests being managed by a plurality of other users;
c) including an early warning system identifying one or more procurement requests at risk of delayed awards, loss of government funds, poorly developed requirements and poorly plan procurements;
d) including a plurality of video tutorials and templates that are linked to one or more specific activities whereby a user can select any of said plurality of video tutorials and templates to help guide the user when performing one of said one or more specific activities;
e) providing a plurality of different user roles and allows each of said different user roles to search, filter and access files through multiple ways, including by lists of projects, activities, repositories and reports; and
f) providing an ask the experts capability an ask the experts capability to enable users to ask acquisition-related questions to which said facilitated intelligent needs development application provides ad-hoc responses to new questions that have not been posed by any user or answered previously, as well as pre-programmed responses to questions previously posed or answered.

17. A method for planning a government procurement request using an intelligent process embedded in a facilitated intelligent needs development application for execution on a server comprising the steps of:
providing a graphical user interface through which a user, such as a requirements owner, can manage a plurality of aspects of a government procurement requests throughout a life cycle of a government procurement, including requirements development, market research, acquisition planning and procurement request submission to the contracting office;
providing access to the facilitated intelligent needs development application by predetermined user roles for a plurality of users to manage a plurality of government procurements, wherein said plurality of users includes one or more of the following: requirements owner, program manager, contracting officers, contracting officer's representatives, supervisory personnel of said contracting officers and said program managers, security officers, technical representatives, and accountants;
providing access to the facilitated intelligent needs development application to one or more supervisory personnel to enable said one or more supervisory personnel to review the planning and analysis of a plurality of government procurement requests being managed by a plurality of other users;
identifying automatically by an early warning system one or more projects at risk of delayed awards, loss of government funds, poorly developed requirements and poorly plan procurements;
automating a process for performing market research that guides a user through a market research methods and consideration process that prompts the user with questions to shape steps necessary to complete the market analysis;
providing one or more video tutorials and templates that are linked to one or more specific activities, whereby a user can select any of the one or more video tutorials and templates to help guide the user when performing one of said one or more specific activities;
providing a plurality of different user roles and allowing each of said different user roles to search, filter and access files through multiple ways, including by lists of projects, activities, repositories and reports; and
providing an ask the experts capability to enable users to ask acquisition-related questions to which said facilitated intelligent needs development application provides ad-hoc responses to new questions that have not been posed by any user or answered previously, as well as pre-programmed responses to questions previously posed or answered.
